(19) United States
(12) Patent Application Publication
(10) Pub. No.: US 2024/0346800 A1
(43) Pub. Date: Oct. 17, 2024

(54) TAG IDENTIFICATION

(71) Applicant: TruTag Technologies, Inc., Kapolei, HI (US)

(72) Inventors: Philip Kwong, Honolulu, HI (US); Alexandre Fong, Orlando, FL (US); Denis Ivanov, Pleasant Hill, CA (US); Pavel Denisov, Emeryville, CA (US)

(21) Appl. No.: 18/624,922

(22) Filed: Apr. 2, 2024

Related U.S. Application Data
(60) Provisional application No. 63/456,974, filed on Apr. 4, 2023.

(51) Int. Cl. G06V 10/44; G06T 7/194; G06V 10/56; G06V 10/60; G06V 20/70

(52) U.S. Cl. CPC G06V 10/44; G06T 7/194; G06V 10/56; G06V 10/60; G06V 20/70

(57) ABSTRACT

A system for identifying tags comprises an imaging sensor and a processor. The imaging sensor acquires image(s) of tag(s) from light reflected from the tag(s) on a tagged item. The processor is configured to: receive the image(s) and a library of tag types; using the image(s), determine feature metrics using a machine learning algorithm and is based on an image processing, manipulation, and/or correction; using the feature metrics and the library of tag types, determine a tag type of the tag(s) in the image(s) based on a local maxima determination, a bounding box generation, a tag candidate patch extraction, a tag candidate segmentation, a tag candidate feature metric determination, and/or a comparison to a model; determine a confidence level of the tag type; and in response to the confidence level being above a threshold level, provide the tag type determined.

### CROSS REFERENCE TO OTHER APPLICATIONS

This application claims priority to U.S. Provisional Patent Application No. 63/456,974 entitled TAG IDENTIFICATION filed Apr. 4, 2023 which is incorporated herein by reference for all purposes.

### BACKGROUND OF THE INVENTION

A producer or reseller of items (including ingredients and components of such items)—for example a manufacturer, but also including other parties in the entire supply and distribution chain such as a supplier, a converter, a wholesaler, a distributor, a repackager, and a retailer—especially, but not limited to, high-value items, faces counterfeiting of the item. Counterfeiting includes the substitution, dilution, addition or omission of ingredients or components of the item compared to its intended product specification, as well as misrepresentation or diversion of the packaged item from its intended course of sale. This leads to loss of potential revenue as counterfeit items are sold in the place of the real item. Also, there can be health or product related damages caused by not using an authentic item as opposed to a counterfeit—for example, the counterfeit can perform differently or not at all as compared to an authentic item. This is particularly acute in industries that can affect health and safety such as industries involved with pharmaceuticals, nutritional supplements, medical devices, food and beverages, construction, transportation, and defense.

In the effort to attain positive health outcomes in a more cost-effective and timely manner, healthcare providers need to focus on the adherence to health regimens, not just the efficacy of specific drugs. Understanding when, where and how often medicine is prescribed by a doctor, accurately and timely dispensed from a pharmacy, received by a patient, and consumed by the patient is helpful in understanding and verifying the effectiveness of the overall health regimen. Recording and collecting the data for appropriate analysis and study while also being able to confirm the underlying identity of the medicine at each stage is important to the reliability of the information collected.

Covert, overt, and/or semi-covert tags (e.g., microtags, taggants, physical and chemical markers, etc.), including edible and safe-to-ingest forms, are an accepted method to identify and authenticate a variety of items including on-dose tagging of solid oral form drug products, food items, packaging materials, and product labels. However, there is a lack of convenient machine-readable methods to identify a sparsity of such tags and to differentiate the various tag types.

### BRIEF DESCRIPTION OF THE DRAWINGS

Various embodiments of the invention are disclosed in the following detailed description and the accompanying drawings.

FIG. 1 is a diagram illustrating an embodiment of a tag identification system.

FIG. 2A is a flow diagram illustrating an embodiment of a process for generating a first model.

FIG. 2B is a flow diagram illustrating an embodiment of a process for generating a second model.

FIG. 3A is a flow diagram illustrating an embodiment of a process for classifying a tag.

FIG. 3B is a flow diagram illustrating an embodiment of a process for classifying additional identifying features.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for identifying tags is disclosed. The system comprises an imaging sensor and a processor. The imaging sensor acquires one or more images of one or more tags from light reflected from the one or more tags on a tagged item. The processor is configured to receive the one or more images and a library of tag types. Using the one or more images, the processor is configured to determine a set of feature metrics. Determining the set of feature metrics uses a machine learning algorithm and is based at least in part on one or more of an image processing, manipulation, or correction. Using the set of feature metrics and the library of tag types, the processor is configured to determine a tag type of the one or more tags in the one or more images. Determining the tag type is based at least in part on one or more of a local maxima determination, a bounding box generation, a tag candidate patch extraction, a tag candidate segmentation, a tag candidate feature metric determination, or a comparison to a model. The processor is further configured to determine a confidence level of the tag type. In response to the confidence level being above a threshold level, the processor provides the tag type determined.

In some embodiments, a library of tag types comprises a collection of sets of feature metric values, wherein each set of feature metric values corresponds to, and is used to identify, a particular tag type. In various embodiments, image processing, manipulation, and/or correction comprises one or more of: an image segmentation (e.g., a semantic or instance segmentation), the generation of a composite image, a patch extraction, a feature extraction, a feature compression, a deep feature extraction, a feature fusion, a feature classification, a confidence level determination, an image cropping or binning, a white balance correction, a background color subtraction, etc.

An integrated, self-contained system for rapid detection and identification of tag types (e.g., a particular type of microtag, taggant, chemical marker, physical marker, rugate filter, interference filter, pigment, flake, platelet, glitter, granule, etc.) on tagged items is disclosed. The system comprises an imaging sensor, focusing optics, and a data acquisition and processing computer platform. In various embodiments, the system comprises an illumination source(s), sample fixturing, automated sample loading, scanning, analysis, and/or automated image capture to improve the ability to detect and identify different tag types (e.g., a rugate microtag type) on a tagged item. In various embodiments, the color of a tag or tag type is a result of a tag's inherent chemical or physical material properties or is a result of one or more coatings on a tag surface.

In various embodiments, the system is integrated into an in-line or offline inspection system (e.g., in pharmaceutical or food processing and packaging facilities). In some embodiments, the system is integrated into a distributed computing and communications environment.

In some embodiments, ambient light (e.g., indirect light, sunlight, room light, streetlights, etc.) projects an image of the sample via the focusing optics onto the imaging sensor. In some embodiments, light from a directed illumination source (e.g., a smartphone flash) is used to project an image of the sample onto the imaging sensor. In some embodiments, tags in the sample are illuminated with a particular color of light (e.g., a laser light) to stimulate a response from the tag (e.g., a fluorescent marker or dye). The imaging sensor renders a digital image which is captured by the processing computer (e.g., a smartphone chipset).

The imaging sensor is used to collect one or more images of one or more tags on a tagged item (e.g., a tagged pill, a tagged package, a tagged packaging label, a tagged food item, etc.), whereby each image in the series of images represents the image of the tagged item at a single point in time and/or position or physical orientation, and/or at a specific wavelength, or wavelength or color band.

In various embodiments, one or more composite images are generated from two or more images. For example, in multi-spectral and hyperspectral imaging systems, each image of a total image data set comprises a narrower wavelength range than the entire wavelength range encompassed by the total image data set. For example, a multi-spectral data set may comprise measuring reflectances within four other (narrower) bands, including the blue, green, and red wavelengths of the visible spectrum, and the near-infrared band, while individual images within a hyperspectral ‘data cube’ may comprise a wavelength range of only 1 to 2 nm. The number of individual images within a multi-spectral data set ranges typically from 3 to 20 while the number of individual images within a hyperspectral data cube often comprises hundreds of contiguous spectral bands. A ‘composite image’ herein refers to the collective individual images within a total image dataset or data cube.

In the following, the term ‘collective images’ is used to refer to any appropriate combination of one or more composite images and/or one or more individual images.

In various embodiments, the collective images provide an indication of the presence of a tag type and/or multiple tag types and/or its concentration (i.e., the number of tags per area, image, or sample). In various embodiments, one or more thresholds based on statistical likelihood are applied when analyzing the collective images to provide a binary or multiplexed answer or response (e.g., the presence or absence of a particular tag type, the presence of multiple tag types and/or their respective concentrations, flags, or warnings, etc.). In some embodiments, thresholds are applied to the confidence level output from one or more models (e.g., the confidence level of the first model should be greater than some threshold, t1, and the confidence level of the second model should be greater than some threshold, t2). In some embodiments, thresholds are applied on individual and/or collective images (e.g., the minimum number of tags within a single image should be greater than some threshold, t3, and the minimum number of tags within a set of collective images should be greater than some threshold, t4). In various embodiments these thresholds are applied such that all conditions must be satisfied, a subset of these conditions must be satisfied, and/or a conditional list of conditions must be satisfied to determine the answer or response (e.g., the intensity of a pixel to be considered for additional processing should be greater than some threshold, t5, or if the hue of the pixel falls within a given range defined by some threshold, t6, then the intensity of a pixel to be considered for additional processing should be greater than some threshold, t7). In some embodiments, the condition for each threshold must be satisfied for the tag candidate to be classified as a specific tag type. In some embodiments, the condition for each threshold is that a tag should be above or below a given threshold.

In some embodiments, additional identifying features of the tagged item are determined. For example, the additional identifying features comprise one or more of a quick response (QR) code, a barcode, a two-dimensional matrix, a data matrix, a logo, a serial number, an item shape, an item size, a luminosity, a color, a mark, an indicium, or a randomly serialized marker. In some embodiments, the additional identifying features are used in combination with an identified tag type to both identify and authenticate a tagged item (i.e., to confirm the tagged item's authenticity).

In various embodiments, optical character recognition (OCR) methods are used to read text and/or feature detection algorithms are used to identify other types of symbology imprinted on the tagged item. For example, text and other symbology types include one or more of a debossing mark on a drug tablet, a unique identifier imprinted on a drug capsule, product information printed on a label (e.g., the National Drug Code number), a logo, a serial number, article size, article shape, article color, etc. For example, for solid oral dosage form human drug products, the imprint code on the tablet or capsule, when used in conjunction with the product's size, shape, and color, permits the identification of the drug product, the active ingredient(s), strength, and the manufacturer or distributor of the product. In some embodiments, OCR methods utilize a Tesseract OCR engine. In various embodiments, OCR methods comprise one or more open-source methods (e.g., OCRopus, Kraken, Calamari OCR, Keras OCR, EasyOCR, etc.) or commercial OCR Application Programming Interfaces (e.g., Amazon Textract, Amazon Rekognition, Google Cloud Vision, Microsoft Azure Computer Vision, Cloudmersive, Free OCR, Mathpix, etc.). In various embodiments, a Hu Moment, a Histogram of Oriented Gradients, a Key Point Matching, or a Neural Network algorithm is used for logo detection.

In various embodiments, the additional identifying features are used prior to tag type determination. For example, reading a QR code on the tagged item enables pre-loading of image acquisition settings and/or the correct machine-learning model for tag classification. In various embodiments, the image acquisition settings and/or the correct machine-learning models for tag classification comprise one or more of a focusing algorithm, a focusing position, an exposure algorithm, an exposure value, a white balance algorithm, a white balance setting, a channel or band selection(s), an image processing configuration setting, a segmentation configuration setting, a tag filtering configuration setting, a tag concentration specification, a scan configuration setting, or any other appropriate feature detection algorithm and/or configuration setting. For example, a barcode on a tagged item enables loading and displaying the related product information to the system user (e.g., so the system user can confirm the correct product has been identified prior to item authentication).

In the disclosed system, the collective images of tags on a tagged item are passed to a classification algorithm (e.g., a tag labeling or typing algorithm). In some embodiments, the images are segmented prior to being passed to a classification algorithm.

For example, pixels representing tags are segmented from the image background and a binary segmentation mask is output for each image. Using the binary segmentation mask, the relevant pixels are selected to outline a tag or tag cluster. A tag cluster is a group of two or more tags in physical proximity such that each individual tag of the tag cluster cannot be fully outlined by its own bounding box. In some embodiments, image background pixels are used as part of the tag filtering algorithms (e.g., to ensure the tag is sufficiently bright relative to its background, or to incorporate background subtraction techniques to normalize tag optical characteristics).

Feature extraction empirically determines features of interest (e.g., size, shape, color, intensity, saturation, etc.) to extract from each tag patch in order to generate a set of feature metrics for each tag patch. For example, feature metrics (e.g., one or more tag characteristics) deemed significant criteria for tag type identification, and/or the associated statistical thresholds for each tag type that have been established as indicating significance, are used to generate a set of feature metrics for each tag type. In some embodiments, features are manually determined by a human user to generate a set of feature metrics for each tag patch. In various embodiments, features and/or feature metrics are automatically determined.

As used herein, the term ‘feature’ is typically used as a general characteristic (e.g., shape, color, intensity, etc.) while a ‘feature metric’ is a more specific value of the general characteristic (e.g., round, red, bright, etc.) useful in classifying tag and/or product types. In various embodiments, the level of feature metric specificity required is determined from generating and training a classification model (as described herein) to meet a desired confidence level. For example, there are a variety of red pill types on the market but differing in multiple other feature characteristics from product to product (e.g., by dosage, size, active ingredient, etc.). Differentiating one red pill product from another based on the red color feature metric alone may require a more specific determination of the feature metric (e.g., the color's precise hue, chroma, brightness, etc.). Alternatively, if additional identifying feature metrics are used in combination to classify or identify a given product, color specificity may not need to be as precise as using the general color family alone. In what follows, the terms ‘feature(s)’ or ‘feature metric(s)’ are sometimes used interchangeably and as such, are not meant to limit their appropriate interpretation by those skilled in the art.

In various embodiments, feature metrics comprise one or more of a size, a shape, a color value, a saturation value, an intensity value, a color value standard deviation, a saturation value standard deviation, an intensity value standard deviation, a relative color value, a relative saturation value, or a relative intensity value, wherein the relative color, saturation, or intensity values are relative to the image background surrounding one or more tag types. In various embodiments, the color, the saturation, or the intensity feature metrics comprise any of an absolute value, a standard deviation, and/or a relative value. In various embodiments, colors are determined using a hue, saturation, lightness (HSL) color model; a hue, saturation, value (HSV) color model; a red, green, blue (RGB) color model; or any other appropriate type of color model.

In some embodiments, feature compression is used to reduce data size while maximizing information. The resultant compressed version of the original tag patch reduces training and prediction times, as well as reducing computer memory requirements.

In some embodiments, deep feature extraction is used to extract additional tag features (e.g., latent tag features) through deep learning methods. For example, latent tag features comprise features, patterns, and differences that are not obvious or discernable by human interrogation but that the deep learning methods determine are significant. Additional features of interest can be extracted using deep supervised learning to generate tag features that are difficult and expensive to manually encode, as well as latent features embedded in the data.

Feature fusion generates a list of combined features for each patch by appending the empirically determined features to a list of extracted features generated from the deep feature extraction process.

Feature classification uses a deep supervised learning model to classify the tag type. Patch features (and/or feature metrics) of tag images are passed to a machine learning algorithm (e.g., a support vector machine), to a residual neural network classification algorithm (e.g., a ResNet-based classification algorithm, or to any other appropriate type of neural network) for training against sets of feature metrics that correspond to various tag types to produce a class prediction model.

Once trained, these algorithms can be used to recognize, identify, and mathematically group feature metrics associated with specific tag types of interest on an unknown item. Such characteristics include, for example: a size, a shape, a color value, a saturation value, an intensity value, a color value standard deviation, a saturation value standard deviation, an intensity value standard deviation, a relative color value, a relative saturation value, a relative intensity value, etc.

In various embodiments, tag type classification is based on morphology (i.e., shape) and/or intensity (i.e., distribution of brightness). In some embodiments, the algorithms utilize both color and spatial (e.g., shape and size) characteristics in their training.

In various embodiments, one or more machine learning models are trained using hierarchical feature learning (i.e., ‘layered learning’). For example, the first layers of the neural network model are trained to learn representations of basic (low-level) features, such as edges. Further down the network, layers output representations of more specific features, corresponding to parts of the object (e.g., corner angles, protrusions, etc.). After the last layer, the representations are high-level and allow a clear separation between different objects with the network having learned to distinguish among the different classes.

In various embodiments, the one or more neural network models are trained using spectral data (e.g., spectral data from tags detected by a bounding box model). For example, spectral data from a spectral imaging sensor (e.g., a spectral imager, a multispectral imager, a hyperspectral imager, etc.). In various embodiments, the one or more neural network models are trained to match the observed spectral data with a library of spectral data corresponding to known tag types.

In various embodiments, the output of the one or more neural network models provides the class label of an identified tag type (e.g., to a system user). In some embodiments, a single tag candidate must be classified by one or more models for the final class to be identified (e.g., a tag candidate must be classified as a valid tag class from model 1 and be classified as a valid tag class from model 2 to be identified as a valid tag class for the system user as the final result). In some embodiments, a single tag candidate must be classified by one model and other image characteristics must be classified as a valid class for the final class label to be identified (e.g., a tag candidate must be classified as a valid tag class from model 3 and the image must be classified as a valid logo class from model 4). In some embodiments, a tag may need to be passed through multiple models to be properly classified. As an example, consider two models (model A and model B)—in order for a tag be identified as class 1, the system may require that it be classified as class 1 in model A but also as class 0 in model B, or as class 1 in both models A and B, or class 1 in either model A or model B, or any other appropriate combination of conditions either AND'ed or OR'ed or combined in any other manner. In various embodiments, the provided class label of an identified tag type includes related metadata. For example, related metadata comprising time and date, a level of confidence, the number and/or density (i.e., a number of tags per unit area) of the identified tag types, a plot or graph of the associated spectral data, etc.

In various embodiments, wherein the tagged items presented are sparsely tagged, methods for anomaly detection and targeting at the pixel and sub-pixel scale based on statistical and machine learning algorithms are used to rapidly locate and identify individual tags. Sparsely distributed samples may be due to economic concerns to minimize the cost of the applied tags and/or to maintain the aesthetics and/or visual covertness of the tagged sample.

In various embodiments, the disclosed system illustrates a method for rapidly locating and identifying various tags comprising (i) a determination of whether there are sufficient tags found with the tag type of interest to state that the sample can be authenticated (e.g., with a minimum number of tags, at a threshold confidence level, etc.), (ii) a determination of insufficient tags found, either with or without the tag type of interest, to state that the sample cannot be authenticated (e.g., inconclusive or suspect), or (iii) a determination that sufficient tags were found without the tag type of interest to state that the sample is suspect or mislabeled.

In some embodiments, the system is controlled by the user through a computer interface (i.e., the User Interface (UI)). In various embodiments, the UI provides a means to (i) specify which products are to be identified, (ii) which tag type(s) are to be identified, (iii) which non-tag feature metrics are to be identified, (iv) which algorithms are to be applied (e.g., tag only, non-tag feature metric(s) only, tag and non-tag feature metric(s), etc.), (v) additional manually entered or automatically captured information about the specific sample, system, or user, (vi) what metadata is to be reported, (vii) provide additional product and/or system background information, and/or (viii) initiate the process of automatically searching for and identifying tags. For example:
1. Input tag types(s) of interest into UI
2. Manually load and/or position sample
3. Set a threshold within the UI
4. Report results via the UI (e.g., the number of tag candidates found, the number of tag candidates above a threshold confidence level found, the number of tag patches above a selected confidence level that contain the tag type of interest, the number of tag patches not containing the tag type of interest, a pass/fail output for each tag type of interest, etc.).

In various embodiments, sample loading and/or positioning are automated. For example, an automated sample-slide loading and unloading or handling system is integrated into the system to facilitate and expedite the automated analysis of large sets of samples. In various embodiments, the UI will provide an option to allow the user to calibrate and/or train the algorithm for a tag type of interest through a guided process (e.g., an application wizard). For example, the selection of a calibration option guides the user through a process that uses calibration standards (e.g., an optical grid standard, a white balance calibration standard, or any other appropriate calibration standard).

The system addresses limitations of other machine learning identification technologies (e.g., machine learning identification technologies useful for tag type detection and identification) by providing a convenient machine-readable system and method that can identify a sparsity of tags and differentiate one tag type from another.

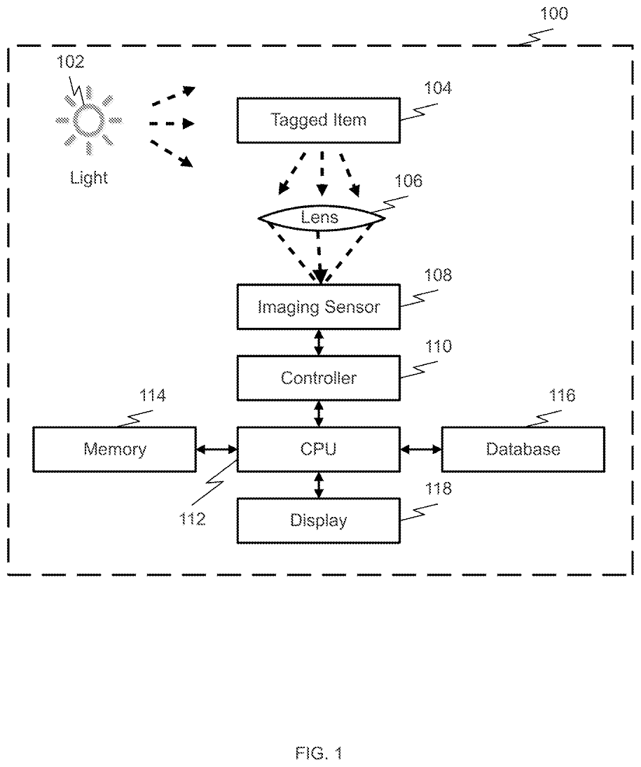

FIG. 1 is a diagram illustrating an embodiment of a tag identification system. In the example shown, tag identification system 100 comprises light source 102, tagged item 104, focusing lens 106, imaging sensor 108, controller 110, central processing unit (CPU) 112, memory 114, database 116, and display 118.

In the example shown, light source 102 (e.g., ambient light, light from a directed light source, etc.) provides light onto a tagged item that in turn is reflected from tagged item 104 and directed through a focusing lens 106 onto imaging sensor 108. An instruction set residing in memory 114 and operating in CPU 112 directs via controller 110 the process of taking and receiving images of tagged item 104. One or more images of tagged item 104 are received by CPU 112 for processing and/or storage in database 116. Display 118 provides a user interface that allows initiation of the tag identification process as well as receiving results as to the tag type. In some embodiments, the one or more images of tagged item 104 are also analyzed for additional features that allow identification of the tagged item as well as tag type. In various embodiments, the identified additional features (and/or additional feature metrics) and the identified tag type are used to authenticate tagged item 104.

In various embodiments, light source 102 comprises broadband light, narrowband light, coherent light, incoherent light, collimated light, focused light, or any other appropriate type of light. In various embodiments, tagged item 104 comprises a tagged pill, a tagged package, a tagged packaging label, a tagged food item, or any other appropriate tagged item. For example, tagged item 104 comprises a drug product, a food product, a tablet, a capsule, a label, a container, a seed, a consumer product (or any part thereof), an electronic material (or any part thereof), an industrial product (or any part thereof), or a package.

In various embodiments, focusing lens 106 comprises a number of optical components (e.g., lenses, filters, windows, optical flats, prisms, polarizers, beamsplitters, wave plates, fiber optics, mirrors, retroreflectors, etc.). In some embodiments, focusing lens 106 is also used to shape light from light source 102 (e.g., to illuminate tagged item 104 with shaped light).

Light from light source 102, after having reflected from tagged item 104, enters image sensor 108. In various embodiments, image sensor 108 comprises a solid-state sensor, a complementary metal-oxide semiconductor (CMOS) sensor, a charge-coupled device (CCD) sensor, a staring array, a red-green-blue (RGB) sensor, an infrared (IR) sensor, an RGB and IR sensor, a Bayer pattern color sensor, a multiple band sensor, or a monochrome sensor.

In some embodiments, CPU 112 is used for controlling and/or coordinating the measurement. For example, CPU 112 is used to indicate turning light source 102 on or off, indicate acquiring an image (e.g., an image of tagged item 104) using image sensor 108, receive data from image sensor 108, from light source 102 (e.g., on/off status, etc.), display an interface (e.g., on display 118), receive commands, or any other appropriate function for CPU 112 in making a measurement.

In some embodiments, tag identification system 100 of FIG. 1 is configured into a compact, self-contained, battery-operable, portable version for use in the field (e.g., in remote operating environments). In some embodiments, tag identification system 100 comprises a mobile device (e.g., a smartphone or a tablet). In some embodiments, tag identification system 100 comprises a microscope. In various embodiments, tag identification system 100 includes thermal and/or ingress protection.

In various embodiments, image sensor 108 is used to acquire one or more images of tagged item 104 (e.g., images of one or more tags on tagged item 104) illuminated by one or more of ambient light, broadband light, narrowband light, coherent light, incoherent light, collimated light, focused light, or any other appropriate type of light. In various embodiments, more than one image sensor, and/or sensor type, is used during the operation of tag identification system 100 (e.g., when training tag identification system 100). In various embodiments, partial processing of images acquired by image sensor 108 happens as part of, or immediately following image acquisition—for example, adjusting image white balance (e.g., based on a known sensor response), image resolution, etc., using a calibration table, etc. In various embodiments, one or more additional image acquisitions of tagged item 104 (e.g., a ‘next image’ acquisition) repositions tagged item 104 within the field of view of image sensor 108 (e.g., as part of training tag identification system 100, as part of product authentication, etc.). For example, tag identification system 100 is trained to recognize tag and/or product types from a multiplicity of spatial and/or illumination orientations of tagged item 104 relative to image sensor 108, and/or for a multiplicity of image sensor types.

In some embodiments, CPU 112 is used to determine a type of each of the one or more tags on tagged item 104, wherein determining the tag type uses a machine learning algorithm, and wherein determining the tag type is based at least in part on one or more of a local maxima determination, a bounding box generation, a tag candidate patch extraction, a tag candidate segmentation, a tag candidate feature metric calculation, or a comparison to a model (e.g., a machine learning model). In various embodiments, CPU 112 utilizes one or more of the following machine learning algorithms to determine the tag type: a support vector machine model, a neural network model, a bounding box model, a clustering algorithm, or a classifier algorithm.

In various embodiments, tag identification system 100 provides the determined tag type of tagged item 104 and/or the associated metadata generated during analysis of the collective images obtained from tagged item 104. In some embodiments, tag identification system 100 provides identifying product information of tagged item 104. In some embodiments, tag identification system 100 provides a confirmation of tagged item 104's authenticity (e.g., authenticity determined using identifying product information of tagged item 104 and the identified tag type of tagged item 104). For example, the tag type, associated metadata, product information, and/or product authenticity of tagged item 104 is provided to a system user via display 118 or to a cloud-based database for user review.

In various embodiments, a system user is instructed to contact others depending on the provided information. For example, tagged item 104 is determined by tag identification system 100 to be a suspect product and the user is instructed to contact the appropriate individual(s) (e.g., a security team member, quality control personnel, a health care practitioner, etc.). In some embodiments, tag identification system 100 includes integrated email or phone support. In some embodiments, tag identification system 100 redirects the system user to another source of product information. For example, a QR code on the tagged item is used to direct the system user to a webpage that contains relevant product information, or a serial number as read by the OCR algorithm of tag identification system 100 redirects the system user to query a cloud-based database to display item information.

In some embodiments, tag identification system 100 includes login functionality to allow only approved users to use the system. In some embodiments, tag identification system 100 includes a calendar reminder function to instruct the system user when to authenticate a tagged item. For example, a system user is reminded to take a prescribed tagged drug product to ensure patient compliance towards an improved health outcome.

In some embodiments, tag identification system 100 includes a manual user override. For example, if product information about tagged item 104 cannot be retrieved from the collective images—for example, the OCR algorithm cannot read a tagged drug tablet's debossing mark or reads it incorrectly—the system user is prompted to manually add the information. For example, the system user adds the debossing mark information to tag identification system 100 via display 118 (e.g., a touch screen user interface). In some embodiments, the manual user override is used to stop acquiring images (e.g., CPU 112 fails to automatically stop acquiring images, the user decides to interrupt the process, etc.).

In some embodiments, tag identification system 100 is trained to identify tags of a type. In some embodiments, tag identification system 100 is trained to differentiate one tag type from a second tag type. In some embodiments, tag identification system 100 is used to generate a set of feature metrics from ground truth images of a known tag type (e.g., a set of feature metrics useful for training the tag identification system). Ground truth tag images are “true and accurate” tag images that are typically made and confirmed by one or more human experts. In various embodiments, the set of feature metrics from ground truth images of a known tag type is used by tag identification system 100 to identify a tag type on tagged item 104 and/or differentiate the first type of one or more tags on tagged item 104 from a second tag type.

In various embodiments, ground truth information is information about images (e.g., images of samples containing tags) or samples (e.g., samples containing tags) that is known to be real or true, provided by direct observation and measurement (i.e., empirical evidence) as opposed to information provided by inference. For example, ‘known samples’ and ‘known images’ comprise samples and images with corresponding ground truth information about the respective samples and images.

In some embodiments, tag identification system 100 is trained to identify tagged item 104. For example, tag identification system 100 is configured and/or trained to recognize additional identifying features of tagged item 104 in order to identify tagged item 104. For example, additional identifying features comprise one or more of a quick response code, a barcode, a two-dimensional matrix, a logo, a serial number, an item shape, a luminosity, a color, a mark, an indicium, a randomly serialized marker, or any other appropriate additional identifying feature. In various embodiments, tag identification system 100 is configured and/or trained to read text, or other character information, imprinted on tagged item 104 in order to identify tagged item 104. In various embodiments, tag identification system 100 is configured and/or trained to both identify and authenticate tagged item 104 using the additional identifying features in combination with an identified tag type. In various embodiments, tag identification system 100 is configured and/or trained to identify tagged item 104 using the additional identifying features without using an identified tag type.

In various embodiments, tag identification system 100 is trained using one or more neural network models. For example, a convolutional neural network (CNN), a region-based convolutional neural network (R-CNN), a Fast R-CNN model, a Faster R-CNN model, a You Only Look Once (YOLO) model from the family of YOLO models, or any other appropriate neural network model.

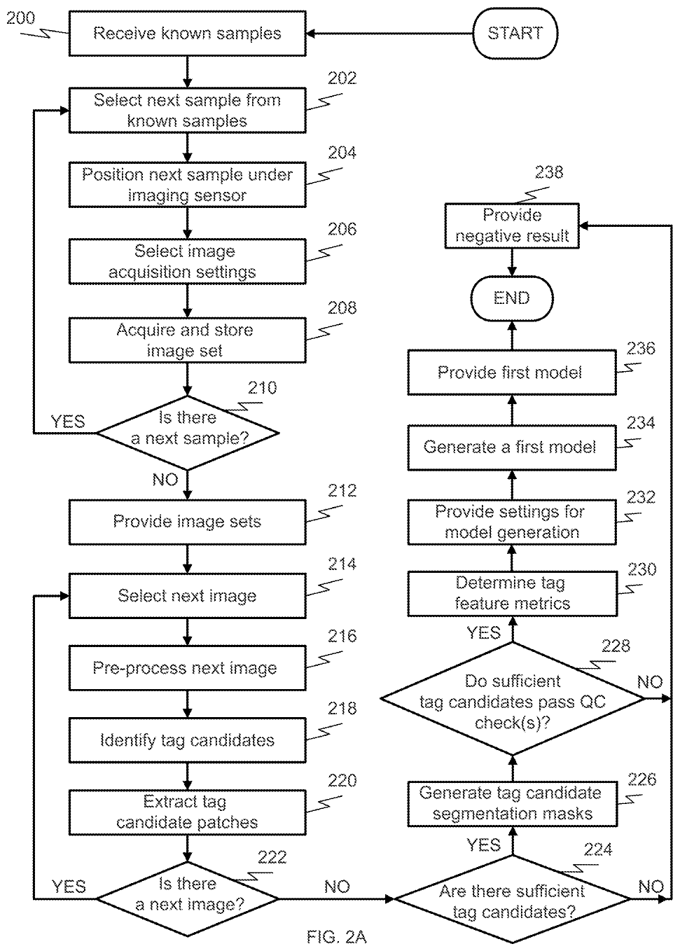

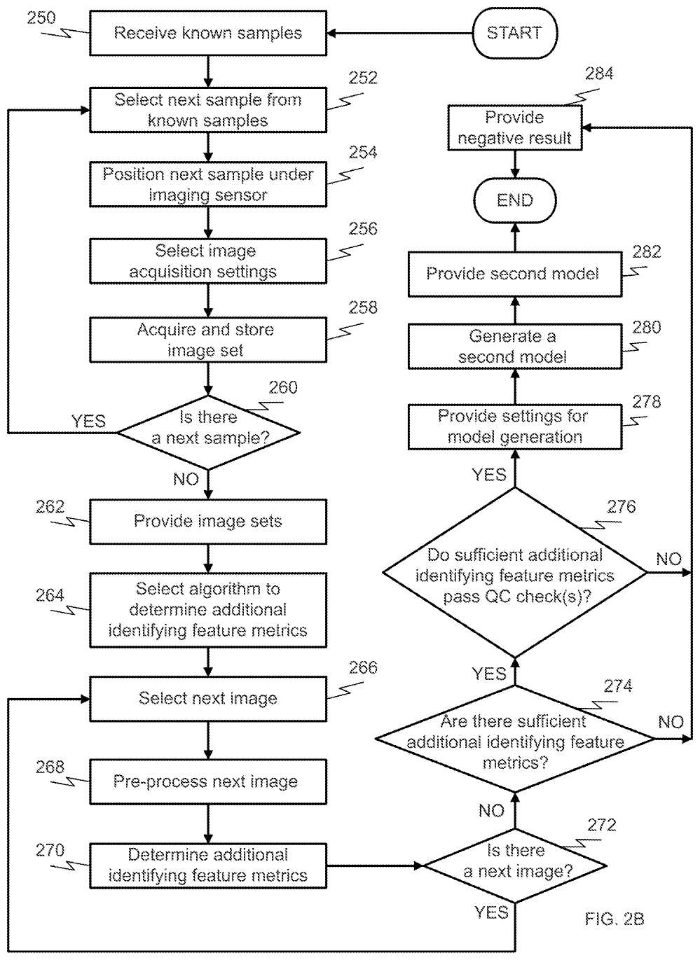

FIG. 2A is a flow diagram illustrating an embodiment of a process for generating a first model. In some embodiments, the process of FIG. 2A is performed using tag identification system 100 of FIG. 1. In the example shown, in 200, known samples are received. For example, known samples containing tags are received by the user of the tag identification system, wherein the sample and the one or more tag types are known (e.g., as determined, by direct observation or measurement). For example, multiple pills with a known tag type applied to the pills (e.g., applied to the surface of the pills via a pill coating) are received. In various embodiments, different samples containing the same one or more tag types are received. For example, pills of different size, shape, color, markings, etc., all with the same one or more tag types, are received. In some embodiments, samples with no tags are received. For example, samples with no tags are used to train the first model to recognize untagged samples, or to recognize additional feature metrics of the samples.

In 202, a next sample is selected from the known samples. For example, a next pill is selected from a batch of known tagged samples of pills. In 204, the next sample is positioned under an imaging sensor. For example, the next pill from a batch of known pill samples is positioned under the imaging sensor (e.g., positioned by hand, using a fixture or mount, etc.) at the desired coordinate. For example, the sample is positioned by adjusting its position relative to the imaging sensor until one or more tags are observable in the field of view of the tag identification system (e.g., as observable by a human user).

In 206, image acquisition settings are selected. For example, image acquisition settings comprising one or more selections of an illumination source(s), a region of interest, a focusing algorithm, a focusing position, an exposure algorithm, an exposure value, a white balance algorithm, a white balance setting, a channel or band selection(s), an image processing configuration setting, a segmentation configuration setting, a tag filtering configuration setting, a tag concentration specification, a scan configuration setting, or any other appropriate configuration settings are selected.

In 208, an image set is acquired and stored. For example, one or more images of one or more tags on a known sample are acquired and stored. For example, one or more images generated by light reflected from one or more tags are acquired by an imaging sensor and stored. In various embodiments, the image sensor comprises a solid-state sensor, a CMOS sensor, a CCD sensor, a staring array, an RGB sensor, an IR sensor, an RGB and IR sensor, a Bayer pattern color sensor, a multiple band sensor, a monochrome sensor, or any other type of appropriate imaging sensor.

For example, an image set is acquired using the selected image acquisition settings and stored in a computer memory or related database. In various embodiments, an image set comprises more than one image (e.g., 3, 8, 12, 15, 20, 30, 43, 50, 100, 200, 500, or any other appropriate number of images). In some embodiments, the number of images in an image set is determined empirically by testing the generated model against known (or ground truth) images so as to achieve a desired level of confidence (e.g., 60%, 70%, 82%, 95%, 98%, 99.3%, or any other appropriate level of confidence when classifying tags in the images. In various embodiments, the number of images in an image set is determined or limited by the availability of known samples.

In various embodiments, the one or more images are stored in computer memory, and/or saved in a data storage unit (e.g., a data storage unit of the computer system controlling the tag identification system). In various embodiments, the one or more images are saved as an image file—for example, a tiff file, a png file, a jpg file, or any other appropriate image file format. In various embodiments, the one or more images are provided to a system user (e.g., displayed on a monitor of the controlling computer system) and/or provided to a software application that allows the user to interact with the one or more images.

In 210, it is determined whether there is a next sample. For example, it is determined whether there is a next pill remaining in the batch of known tagged samples of pills that has not been imaged. In response to determining that there is not a next sample, the process returns to 202. In response to determining that there is a next sample, the process flows to 212.

In 212, the image sets are provided. For example, the image sets from all the imaged pill samples are provided to a computer system (e.g., to the memory and/or related database of a computer system that is part of the tag identification system).

In 214, a next image is selected. For example, a next image is selected from the image sets acquired from the imaged pill samples. In 216, the next image is pre-processed. For example, image pre-processing comprises one or more of an image cropping or binning, a white balance correction, an exposure correction (e.g., either automatically or via a calibration table), a background color subtraction, a background correction (i.e., adjusting for the fact that the surrounding target color may impact the perceived color of the tag), filtering out noise, etc.

In some embodiments, pre-processing comprises checking overall image quality. Image quality attributes considered in determining overall image quality comprise one or more of the following: image sharpness, noise, dynamic range, tone reproduction, contrast, color accuracy, distortion, vignetting, exposure accuracy, lateral chromatic aberration (i.e., color fringing), lens flare, color moiré, and/or other visual artifacts, including data compression and transmission losses (e.g., low quality Joint Photographic Experts Group (JPEG) images), oversharpening ‘halos’, loss of fine, low-contrast detail, and repeatability of results. In various embodiments, image quality attributes are classified in terms of measuring only one specific type of degradation (e.g., blurring, blocking, or ringing), or taking into account all possible signal distortions, that is, multiple kinds of artifacts.

In various embodiments, image quality is assessed using objective or subjective methods. For example, image quality methods comprising one of more of single-stimulus, double-stimulus, full-reference, reduced-reference, no-reference, or any other appropriate image quality method is used to assess image quality and/or provide a quality score. For example, the images are passed through an image quality filter (e.g., a manual or automatic image quality filter) to determine a quality score for each image, wherein the quality score for each image is used to determine whether the images should be either discarded or used in generating a first model. In some embodiments, pre-processing of the next image is not performed (i.e., process step 216 is skipped over).

In 218, tag candidates are identified. For example, blob detection methods are employed to identify areas in the next image that exhibit properties that differ from the overall image background (e.g., brightness or color). A blob is a region of the image in which some properties are constant or approximately constant; all the points in a blob can be considered in some sense to be similar to each other. For example, blob detection methods comprise one or more algorithms based on determining local extrema (e.g., local maxima, local minima, specific color maxima, etc.), color thresholding, differential methods, (e.g., based on derivatives of the function with respect to position), etc. In some embodiments, the blob detection methods used to identify tag candidates are trained to look for properties that are consistent with images of tags (e.g., brightness, color, size, etc.).

In 220, tag candidate patches are extracted. For example, patches of individual tags and/or tag cluster candidates in the next image are cropped out from the overall image background. Patches of individual tags or tag clusters candidates comprise localized regions surrounding and including images of the tag or tag cluster candidates.

In some embodiments, patch extraction comprises cropping the one or more images to generate one or more patch images comprising an individual tag image and/or a cluster of tags image. In some embodiments, morphology and tag contours are used to select clusters of contiguous pixels in a mask that forms a cluster of tags. This allows training of clustering or extraction algorithms on ‘atomic’ units of interest within the image, minimizing input size into multi-dimensional deep networks, and allowing for preprocessing and normalizing on a tag-to-tag basis, rather than the whole image. The process can be further refined to individual tags using watershed segmentation and erosion/dilation techniques.

For example, identified blobs in the next image are extracted from the image background after utilizing a bounding box model to localize and/or detect images of tag candidates. In various embodiments, the bounding box model comprises one or more of a Tensor Flow model, a convolutional neural network, a region-based convolutional neural network (R-CNN), a Fast R-CNN model, a Faster R-CNN model, a You Only Look Once (YOLO) model from the family of YOLO models, an EdgeBoxes model, or any other appropriate bounding box model.

In 222, it is determined whether there is a next image. For example, it is determined whether there is a next image remaining in the image set acquired from a batch of known tagged samples. In response to determining that there is a next image, the process returns to 214. In response to determining that there is a next image, the process flows to 224.

In 224, it is determined whether there are sufficient tag candidates. In response to determining that there are insufficient tag candidates, the process flows to 238, a negative result is provided (e.g., provided to the system user via a display within the tag identification system), and the process ends. In response to determining that there are sufficient tag candidates, the process flows to 226. For example, if no tag candidates are found, then the process has no data to generate a model and is unable to continue. If too few tag candidates are found, it may be determined it is not worth generating and/or testing such a model, and/or that it is unlikely that a model generated with too few data points would be sufficiently reliable. The determination of whether there are sufficient tag candidates is an experienced-based judgment that comes from working with the process of FIG. 2A. For example, it may be empirically determined that a minimum of 30, 50, 100, 200, 392, 5000, 9812, 1,000,000 or any other appropriate minimum number of tag candidates should be found before determining that there are sufficient tag candidates to continue the process. In some embodiments, the sufficient number of tag candidates is determined empirically by testing the generated model against known (or ground truth) images so as to achieve a desired level of confidence (e.g., 60%, 70%, 82%, 95%, 98%, 99.3%, or any other appropriate level of confidence) when classifying tags in the next images. In some embodiments, it is determined whether any extracted tag candidate patches from the image match a known tag feature in a library of tag types (e.g., above a threshold confidence value) in order to qualify as a tag candidate.

In 226, tag candidate segmentation masks are generated. For example, a binary segmentation mask is generated for each tag candidate patch (and/or tag candidate cluster patch) that has been extracted from the next image. Using this mask, only the relevant pixels for that tag candidate are selected, background pixels are zeroed, and the image is cropped down to a small patch that covers exactly the area of the tag candidate or tag candidate cluster.

For example, pixels representing tag candidates that have been segmented from the image background are used to generate a binary segmentation mask. In computer graphics, when a given image is intended to be placed over a background, the transparent areas can be specified through a binary mask. This way, for each intended image there are actually two bitmaps: the actual image, in which the unused areas are given a pixel value with all bits set to 0s, and an additional mask, in which the correspondent image areas are given a pixel value of all bits set to 0s and the surrounding areas a value of all bits set to 1s. In some embodiments, binary segmentation masks are generated for each individual tag image and each cluster of tags.

Tag candidate segmentation algorithms can be categorized into semantic segmentation and instance segmentation. Semantic segmentation refers to the partitioning of images into different semantic parts and assigning each pixel to a class (e.g., tag foreground or background). Instance segmentation seeks to identify each instance of the same class, by separately detecting and delineating every single tag candidate shown in the image.

For example, a semantic segmentation program localizes tag boundaries in an image and distinguishes these tag boundaries from the background of the image producing a pixel-wise binary mask. Using the mask, the tag patch is cropped, or extracted from the image background for comparison to a collection of known tag features within the library of tag types. In various embodiments, classical imaging techniques for tag segmentation are used to detect tag boundaries (e.g., watershed transformation, morphological image processing, Laplacian of Gaussian (LoG) filters, pixel classification, etc.). In various embodiments, artificial intelligence (AI) imaging techniques are used for tag segmentation (e.g., U-Net (a Convolutional Network for Biomedical Image Segmentation), Mask R-CNN, etc.).

For example, images of tag candidates are processed to detect and segment tag pixels from the image background before feeding them into a classification algorithm (e.g., a tag feature classification algorithm). In some embodiments, the collective images represent transmitted energy amounts for each of a set of wavelengths or range of wavelengths for a sample; this provides a spectral reflection characterization of the sample. In some embodiments, image segmentation comprises delineation of pixels belonging to one or more tag candidates in a spectral image. In some embodiments, delineation of the pixels comprises determining a foreground and a background.

In various embodiments, the collective images are processed using a combination of one or more machine learning clustering algorithms (e.g., principal component analysis, K-Means, spectral angle mapping that is first trained on samples of known tag types, or any other appropriate algorithm).

Principal component analysis (PCA) is used to simplify complexity in high-dimensional data while retaining trends and patterns by transforming data into fewer dimensions to summarize features. K-Means is an iterative clustering algorithm used to classify data into a specified number of groups by beginning with an initial set of randomly determined cluster centers. Each pixel in the image is then assigned to the nearest cluster center by distance and each cluster center is then recomputed as the centroid of all pixels assigned to the cluster. This process repeats until a desired threshold is achieved. Spectral angle mapping (SAM) compares a given spectra to a known spectrum, treating both as vectors and calculating the “spectral angle” between them and grouping them with respect to a threshold based on that angle.

In some embodiments, the use of strictly unsupervised models eliminates the need to manually determine semantic labels. For example, within the field of machine learning, there are two main types of tasks: supervised, and unsupervised. The main difference between the two types is that supervised learning is done using a ground truth, or in other words, there is prior knowledge of what the output values that the training samples should be associated with. Therefore, the goal of supervised learning is to learn a function that, given a sample of data and desired outputs, best approximates the relationship between input and output observable in the data. Unsupervised learning, on the other hand, does not have labeled outputs, so its goal is to infer the natural structure present within a set of data points. Semantic labeling, or semantic segmentation, involves assigning class labels to pixels. In broad terms, the task involves assigning at each pixel a label that is most consistent with local features at that pixel and with labels estimated at pixels in its context, based on consistency models learned from training data. Semantic labeling when done manually is laborious and requires a large amount of domain knowledge. Thus, the use of strictly unsupervised models prevents the need to manually determine semantic labels.

Semantic labeling can be contrasted against instance labeling. Instance labeling, or instance segmentation, is different from the semantic segmentation method. Semantic segmentation refers to the process of associating every pixel of an image with a class label such as a person, flower, car, and so on. It treats multiple objects of the same class as a single entity. On the contrary, instance segmentation treats multiple objects of the same class as distinct individual instances. For example, assume there is an input image of a street view comprising several people, cars, buildings, etc. If only group objects belonging to the same category are desired, say distinguishing all cars from all buildings, this is the task of semantic segmentation. Within each category, for example people, if it is desired to distinguish each individual person, that will be the task of instance segmentation. Further, if it is desired to have both category-wise as well as instance-wise division, it will be a panoptic segmentation task.

In some embodiments, traditional K-means clustering algorithms are sufficient for background vs. foreground detection. In some embodiments, segmentation performance can be further improved by scaling to a deep autoregressive segmentation model, that defines two clusters by separating on mutual information.

In some embodiments, the original image is grayscale converted, then a threshold method applied, and finally the output is a binary image that bears a mask of gray and black. Thresholding is a type of image segmentation, where pixels of an image are changed to make the image easier to analyze. In thresholding, an image is converted from color or grayscale into a binary image, i.e., one that is simply black and white. Most frequently, thresholding is used as a way to select areas of interest of an image, while ignoring the parts we are not concerned with (e.g., separating foreground from background). In some embodiments, a tag image foreground and background are used to generate a binary segmentation mask. In some embodiments, tag morphology and contours are used to generate the binary segmentation mask. In some embodiments, tag candidate segmentation masks are not generated (i.e., process step 226 is skipped over), and the process flows to 228.

In 228, it is determined whether sufficient tag candidates pass quality control (QC) check(s). For example, it is determined whether sufficient tag candidates are of sufficient image quality to be useful in the generation of a first model. In various embodiments, tag candidate QC checks comprise checking whether spectral properties of the tag candidates are within, above, or below certain threshold limits (e.g., either absolute or relative to the background). In various embodiments, spectral properties are determined using a hue, saturation, lightness (HSL) color model; a hue, saturation, value (HSV) color model; a red, green, blue (RGB) color model; or any other appropriate type of color model. The relative HSV parameters may be in the form of a relative difference (i.e., tag intensity minus background intensity) or a relative ratio (i.e., tag intensity divided by background intensity).

In response to determining that sufficient tag candidates do not pass QC check(s), the process flows to 238, a negative result is provided (e.g., provided to the system user via a display within the using tag identification system), and the process ends. In response to determining that sufficient tag candidates pass QC check(s), the process flows to 230.

In some embodiments, QC checks are performed before determining whether there are sufficient tag candidates (i.e., process steps 224 and 228 are reversed in order). In some embodiments, QC checks are not performed (i.e., process step 228 is skipped over).

In 230, tag feature metrics are determined. For example, tag feature metrics deemed significant for tag type identification, and/or the associated statistical thresholds for each tag type that have been established as indicating significance, are determined for each tag image. In some embodiments, tag feature metrics are manually determined by a human user to generate a set of feature metrics for each tag image (e.g., when first using the process of FIG. 2A to analyze a batch of known samples that have not been previously studied).

In various embodiments, tag feature metrics comprise one or more of a size, a shape, a color value, a saturation value, an intensity value, a color value standard deviation, a saturation value standard deviation, an intensity value standard deviation, a relative color value, a relative saturation value, or a relative intensity value, wherein the relative color, saturation, or intensity values are relative to the image background surrounding one or more tag types.

In some embodiments, tag feature metrics are automatically determined (e.g., automatically determined by a machine learning model that has been trained to identify relevant tag feature metrics). Once trained, these models can be used to recognize, identify, and mathematically group feature metrics associated with specific tag types of interest on a known sample.

In various embodiments, one or more machine learning models are trained using hierarchical feature learning (i.e., ‘layered learning’). For example, the first layers of the neural network model are trained to learn representations of basic (low-level) features, such as edges. Further down the network, layers output representations of more specific features, corresponding to parts of the object (e.g., corner angles, protrusions, etc.). After the last layer, the representations are high-level and allow a clear separation between different objects with the network having learned to distinguish among the different classes.

In various embodiments, the one or more neural network models are trained using spectral data (e.g., spectral data from tags detected by a bounding box model). For example, spectral data from a spectral imaging sensor (e.g., a spectral imager, a multispectral imager, a hyperspectral imager, etc.). In various embodiments, the one or more neural network models are trained to match the observed spectral data with a library of spectral data corresponding to known tag types.

In various embodiments, the output of the one or more neural network models provides the class label of an identified tag type (e.g., to a system user). In various embodiments, the provided class label of an identified tag type includes related metadata. For example, related metadata comprising time and date, a level of confidence, the number and/or density (i.e., a number of tags per unit area) of the identified tag types, a plot or graph of the associated spectral data, etc.

In various embodiments, wherein the tagged items presented are sparsely tagged, methods for anomaly detection and targeting at the pixel and sub-pixel scale based on statistical and machine learning algorithms are used to rapidly locate and identify individual tags. Sparsely distributed samples may be due to economic concerns to minimize the cost of the applied tags and/or to maintain the aesthetics and/or visual covertness of the tagged sample.

In some embodiments, a first set of tag feature metrics is generated by extracting features of interest from each tag or tag-cluster image. For example, morphological features of interest (e.g., size, shape, and intensity distribution) are empirically determined and extracted from each tag image in order to generate a first set of tag feature metrics for each tag image (e.g., metrics deemed significant criteria for identification and the associated statistical thresholds for each that have been established as indicating significance). In some embodiments, features of interest are manually determined by a human user. In some embodiments, feature extraction comprises determining a first set of one or more morphological features of interest from each tag image to generate a first set of feature metrics.

In some embodiments, a second set of feature metrics is generated by extracting additional features of interest from each tag image. In some embodiments, additional morphological tag features (e.g., latent tag features) are extracted through deep learning methods (i.e., ‘deep feature extraction’). Additional features of interest can be extracted using deep supervised learning to generate morphological features that are difficult and expensive to manually encode, as well as latent features embedded in the data. For example, latent tag features comprise features, patterns, and differences that are not obvious or discernable by human interrogation but that the deep learning methods determine are significant. In some embodiments, deep feature extraction comprises determining a second set of one or more morphological features of interest from the tag image to generate a second set of feature metrics.

In various embodiments, deep feature extraction is achieved by flattening the tag images and feeding them pixel by pixel into a fully connected neural network (FCNN) or into a one-dimensional convolutional neural network (1D CNN). In some embodiments, for example when using 2D multichannel patches, a Feature Pyramidal Network (FPN) is used to convolve the input tag image at multiple scales before flattening features, allowing for scale invariant inputs (e.g., tags of different sizes or images at different magnifications). In various embodiments, the FPN, or other appropriate neural network model, outputs a list of extracted features for each tag image input.

In some embodiments, a complete set of tag feature metrics is generated. For example, a complete set of tag feature metrics is generated by ‘fusing’ (or combining) the first and second sets of feature metrics (i.e., ‘feature fusion’). In some embodiments, feature fusion comprises appending the second set of feature metrics to the first set of feature metrics to generate a complete set of feature metrics.

In some embodiments, tag images (and/or the related tag segmentation masks) are compressed in order to reduce image file size while maximizing information. In order to reduce training and prediction times, and avoid large memory requirements, tag images are compressed into embedded features using Primary Component Analysis (PCA). This can be improved (albeit at significant memory and computation cost) by implementing a three-dimensional convolutional neural network (3D CNN) autoencoder. An autoencoder is a type of artificial neural network used to learn efficient codings of unlabeled data (i.e., unsupervised learning). The encoding is validated and refined by attempting to regenerate the input from the encoding. The autoencoder learns a representation (i.e., encoding) for a set of data, typically for dimensionality reduction, by training the network to ignore insignificant data (i.e., ‘noise’). Compressing down to three features allows for 2D classifications rather than 3D classifications thereby saving time and expense. In some embodiments, feature compression comprises spectrally compressing the tag image to generate a compressed tag image.

In 232, settings for model generation are provided. For example, settings specific to acquiring, pre-processing, identifying, extracting, segmenting, checking quality, and detecting features (and/or measuring feature metrics) of the known sample images are provided to the processor of the tag identification system. In some embodiments, the settings for model generation are saved in database (e.g., in a database of the tag identification system). In some embodiments, the settings for model generation are collectively saved in a configuration file for later recall (e.g., by the system user).

In 234, a first model is generated. For example, a first model utilizing one or more of the following machine learning algorithms is generated: a support vector machine model, a neural network model, a bounding box model, a clustering algorithm, or a classifier algorithm. In some embodiments, one or more neural network models are used to classify images of tags. The neural network model used to classify images of tags (i.e., ‘the classifier model’) assigns a class label to one or more tag images outlined by a bounding box. In some embodiments, the classifier model uses sharp edge detection. In some embodiments, the classifier model uses machine vision. In some embodiments, the classifier model uses machine learning approaches. For example, the classifier model uses one or more neural network models to classify tag images that have been detected by the bounding box model. In various embodiments, the one or more neural network models used by the classifier model are the same, different, or a combination of same or different models as used by the bounding box model.

In 236, the first model is provided. For example, the first model is provided to the system user of the tag identification system (e.g., for verification and testing purposes). In some embodiments, the first model is saved to a database (e.g., to a database of the tag identification system or any other appropriate database).

In 238, a negative result is provided, and the process ends. For example, a negative result is provided to the system user of the tag identification system (e.g., via a display of the tag identification system), and the process ends. In some embodiments, a negative result is saved to a database (e.g., to a database of the tag identification system or any other appropriate database). For example, a negative result comprising a list of reasons as to why the process was unable to generate a first model is provided (e.g., insufficient tag candidates identified, insufficient tag candidates that passed the QC check, the actual number of tag candidates identified and/or that passed QC check, or any other appropriate information).

FIG. 2B is a flow diagram illustrating an embodiment of a process for generating a second model. In some embodiments, the process of FIG. 2B is performed using tag identification system 100 of FIG. 1 (e.g., CPU 112 of FIG. 1). In the example shown, in 250, known samples are received. For example, known samples with one or more additional identifying features are received by the user of the tag identification system.

Additional identifying features and feature metrics comprise one or more of a quick response (QR) code, a barcode, a two-dimensional (2D) matrix, a logo, a serial number, an item shape, an item size, a luminosity, a color, a mark, an indicium, a randomly serialized marker, text and other symbology types, or any other appropriate additional identifying feature. For example, text and other symbology types include one or more of a debossing mark on a drug tablet, a unique identifier imprinted on a drug capsule, product information printed on a label (e.g., the National Drug Code number), a logo, a serial number, etc.

In various embodiments, known samples containing or not containing one or more tag types are received (e.g., to generate and/or train a second model that is able to determine one or more additional identifying feature of the known samples). For example, multiple pills (e.g., tablet form pills) with a known debossing mark impressed into the pills are received to generate a second model able to classify the known samples on the basis of the additional identifying feature (i.e., the known debossing mark). In various embodiments, more than one additional identifying features are used to classify the known samples. For example, multiple pills each with the same size, shape, color, and debossing mark are used to generate a second model able to classify the known samples using the multiple additional identifying features.

In 252, a next sample is selected from the known samples. For example, a next pill is selected from a batch of known pill samples (e.g., pills with known debossing marks). In 254, the next sample is positioned under an imaging sensor. For example, the next pill from a batch of known pill samples is positioned under the imaging sensor (e.g., positioned by hand, using a fixture or mount, etc.) at the desired coordinate. For example, the sample is positioned by adjusting its position relative to the imaging sensor until one or more additional identifying features are observable in the field of view of the tag identification system (e.g., as observable by a human user).

In 256, image acquisition settings are selected. For example, image acquisition settings comprising one or more selections of an illumination source(s), a region of interest, a focusing algorithm, a focusing position, an exposure algorithm, an exposure value, a white balance algorithm, a white balance setting, a channel or band selection(s), an image processing configuration setting, a segmentation configuration setting, a tag filtering configuration setting, a tag concentration specification, a scan configuration setting, or any other appropriate configuration settings are selected.

In 258, an image set is acquired and stored. For example, one or more images of one or more additional identifying features on a known sample are acquired and stored. For example, one or more images generated by light reflected from one or more additional identifying features are acquired by an imaging sensor and stored. In various embodiments, the image sensor comprises a solid-state sensor, a CMOS sensor, a CCD sensor, a staring array, an RGB sensor, an IR sensor, an RGB and IR sensor, a Bayer pattern color sensor, a multiple band sensor, a monochrome sensor, or any other type of appropriate imaging sensor.

For example, an image set is acquired using the selected image acquisition settings and stored in a computer memory or related database. In various embodiments, an image set comprises more than one image (e.g., 3, 8, 12, 15, 20, 30, 43, 50, 100, 200, 500, or any other appropriate number of images). In some embodiments, the number of images in an image set is determined empirically by testing the generated model against known (or ground truth) images so as to achieve a desired level of confidence (e.g., 60%, 70%, 82%, 95%, 98%, 99.3%, or any other appropriate level of confidence when classifying tags in the images. In various embodiments, the number of images in an image set is determined or limited by the availability of known samples.

In various embodiments, the one or more images are stored in computer memory, and/or saved in a data storage unit (e.g., a data storage unit of the computer system controlling the tag identification system). In various embodiments, the one or more images are saved as an image file—for example, a tiff file, a png file, a jpg file, or any other appropriate image file format. In various embodiments, the one or more images are provided to a system user (e.g., displayed on a monitor of the controlling computer system) and/or provided to a software application that allows the user to interact with the one or more images.

In 260, it is determined whether there is a next sample. For example, it is determined whether there is a next pill remaining in the batch of known pill samples that has not been imaged. In response to determining that there is not a next sample, the process returns to 252. In response to determining that there is a next sample, the process flows to 262.

In 262, the image sets are provided. For example, the image sets from all the imaged pill samples are provided to a computer system (e.g., to the memory and/or related database of a computer system that is part of the tag identification system).

In 264, an algorithm is selected to determine additional identifying feature metrics. For example, an algorithm is selected to determine additional identifying feature metrics dependent on the specific one or more feature metrics being identified. In some embodiments, one or more algorithms are selected to best identify the one or more feature metrics. In some embodiments, one or more algorithms for determining additional identifying feature metrics are combined into a single overall algorithm specific to the one or more feature metrics being identified. In some embodiments, a hierarchy of additional identifying feature metric determination is followed by the algorithm. In various embodiments, the algorithm compares detected additional identifying feature metrics to a library of known additional identifying feature metrics associated with a known product type. For example, prior to determining the color of a pill, the shape of the pill is first determined and compared to a library of known additional identifying feature metrics to determine whether the shape exists in the known library. If the shape does not exist in the library, model generation can be paused (e.g., by the algorithm querying the system user whether to proceed) so that the library can be updated to include the new samples. In some embodiments, the library (e.g., a library of known feature metrics for a known product type) is dynamic. For example, as the library grows in the course of classifying multiple, new, and additional product types, additional ‘additional identifying feature metrics’ may be necessary to classify a tag or product type that has a subset of similar identifying features. In some embodiments, a new tag type is added to the library of tag types after training the system to differentiate the new tag type from known tag types in the library of tag types. In some embodiments, the tag type corresponds to a pre-defined set of feature metric values. In some embodiments, a pre-defined set of feature metric values corresponding to a known tag type is modified, if necessary, as the library of tag types grows.

In various embodiments, optical character recognition (OCR) methods are used to read text and/or feature detection algorithms are used to identify other types of symbology imprinted on the tagged item. For example, text and other symbology types include one or more of a debossing mark on a drug tablet, a unique identifier imprinted on a drug capsule, product information printed on a label (e.g., the National Drug Code number), a logo, a serial number, article size, article shape, article color, etc. For example, for solid oral dosage form human drug products, the imprint code on the tablet or capsule, when used in conjunction with the product's size, shape, and color, permits the identification of the drug product, the active ingredient(s), strength, and the manufacturer or distributor of the product. In some embodiments, OCR methods utilize a Tesseract OCR engine. In various embodiments, OCR methods comprise one or more open-source methods (e.g., OCRopus, Kraken, Calamari OCR, Keras OCR, EasyOCR, etc.) or commercial OCR Application Programming Interfaces (e.g., Amazon Textract, Amazon Rekognition, Google Cloud Vision, Microsoft Azure Computer Vision, Cloudmersive, Free OCR, Mathpix, etc.). In various embodiments, a Hu Moment, a Histogram of Oriented Gradients, a Key Point Matching, or a Neural Network algorithm is used for logo detection.

In some embodiments, an additional identifying feature comprises relative tag-to-tag information. For example, the relative and/or average distance between tags may be used to differentiate different product classes. In some embodiments, relative tag-to-tag information comprises the relative distance between tags of multiple classes. In some embodiments, relative tag-to-tag information comprises spectral parameters (e.g., relative hue, saturation, value differences and/or distributions, etc.). In various embodiments, relative tag-to-tag information comprises a relative frequency distribution of two or more different tag classes.

In various embodiments, one or more additional identifying features provide product level identification. In various embodiments, one or more additional identifying features provide for instance-level identification of a product.

In various embodiments, the additional identifying features are used prior to tag type determination. For example, reading a QR code on the tagged item enables pre-loading of image acquisition settings and/or the correct machine-learning model for tag classification. In various embodiments, the image acquisition settings and/or the correct machine-learning models for tag classification comprise one or more selections of an illumination source(s), a region of interest, a focusing algorithm, a focusing position, an exposure algorithm, an exposure value, a white balance algorithm, a white balance setting, a channel or band selection(s), an image processing configuration setting, a segmentation configuration setting, a tag filtering configuration setting, a tag concentration specification, a scan configuration setting, or any other appropriate feature detection algorithm and/or configuration setting. For example, a barcode on a tagged item enables loading and displaying the related product information to the system user (e.g., so the system user can confirm the correct product has been identified prior to item authentication).

In 266, a next image is selected. For example, a next image is selected from the image sets acquired from the imaged pill samples.

In 268, the next image is pre-processed. For example, image pre-processing comprises one or more of an image cropping or binning, a white balance correction, an exposure correction (e.g., either automatically or via a calibration table), a background color subtraction, a background correction (i.e., adjusting for the fact that the surrounding target color may impact the perceived color of the tag), filtering out noise, etc.

In some embodiments, pre-processing comprises checking overall image quality. Image quality attributes considered in determining overall image quality comprise one or more of the following: image sharpness, noise, dynamic range, tone reproduction, contrast, color accuracy, distortion, vignetting, exposure accuracy, lateral chromatic aberration (i.e., color fringing), lens flare, color moiré, and/or other visual artifacts, including data compression and transmission losses (e.g., low quality JPEG), oversharpening ‘halos’, loss of fine, low-contrast detail, and repeatability of results. In various embodiments, image quality attributes are classified in terms of measuring only one specific type of degradation (e.g., blurring, blocking, or ringing), or taking into account all possible signal distortions, that is, multiple kinds of artifacts.

In various embodiments, image quality is assessed using objective or subjective methods. For example, image quality methods comprising one of more of single-stimulus, double-stimulus, full-reference, reduced-reference, no-reference, or any other appropriate image quality method is used to assess image quality and/or provide a quality score. For example, the images are passed through an image quality filter (e.g., a manual or automatic image quality filter) to determine a quality score for each image, wherein the quality score for each image is used to determine whether the images should be either discarded or used in generating a first model. In some embodiments, pre-processing of next images is not performed (i.e., process step 268 is skipped over).

In 270, additional identifying feature metrics are determined. For example, additional identifying features and/or associated additional identifying feature metrics deemed significant for product type identification, and/or the associated statistical thresholds for each product type that have been established as indicating significance, are determined. For example, it is determined that the additional identifying feature of color is deemed significant for product type identification, but also that the precise color (i.e., the associated additional identifying feature metric) is required to differentiate one product from another. For example, the color red may be considered to help classify or narrow a product type into one of several possible product types that are also ‘red’, but it is determined further that the exact shade of red (e.g., red with a wavelength of 632 nm) is required to differentiate a specific product from other products that are also red, but of different hues (i.e., different color wavelengths). Further, for example, red with a wavelength of 632 nm with an associated statistical threshold of +/−3 nm is used as forming an acceptance criterion to differentiate one product from other products that are also red, but of different hues.

For example, additional identifying features and feature metrics comprise one or more of a quick response (QR) code, a barcode, a two-dimensional (2D) matrix, a logo, a serial number, an item shape, an item size, a luminosity, a color, a mark, an indicium, a randomly serialized marker, text and other symbology types, or any other appropriate additional identifying feature.

In various embodiments, one or more additional identifying features and/or additional identifying feature metrics are determined. For example, multiple pills each with the same size, shape, color, and debossing mark are determined and used to generate a second model able to classify the known samples using the more than one additional identifying features. In some embodiments, additional identifying features are manually determined by a human user to generate a set of additional identifying feature metrics for each product type. In various embodiments, additional identifying features and/or additional identifying feature metrics are automatically determined.

In various embodiments, optical character recognition (OCR) methods are used to read text and/or feature detection algorithms are used to identify other types of symbology imprinted on the tagged item. For example, text and other symbology types include one or more of a debossing mark on a drug tablet, a unique identifier imprinted on a drug capsule, product information printed on a label (e.g., the National Drug Code number), a logo, a serial number, etc. For example, for solid oral dosage form human drug products, the imprint code on the tablet or capsule, when used in conjunction with the product's size, shape, and color, permits the identification of the drug product, the active ingredient(s), strength, and the manufacturer or distributor of the product. In some embodiments, OCR methods utilize a Tesseract OCR engine. In various embodiments, OCR methods comprise one or more open-source methods (e.g., OCRopus, Kraken, Calamari OCR, Keras OCR, EasyOCR, etc.) or commercial OCR Application Programming Interfaces (e.g., Amazon Textract, Amazon Rekognition, Google Cloud Vision, Microsoft Azure Computer Vision, Cloudmersive, Free OCR, Mathpix, etc.). In various embodiments, a Hu Moment, a Histogram of Oriented Gradients, a Key Point Matching, or a Neural Network algorithm is used for logo detection. In various embodiments, an Object Detection algorithm is used to identify an object (e.g., to act as the identifying feature alone, or in combination with other algorithms).

In 272, it is determined whether there is a next image. For example, it is determined whether there is a next image remaining in the image set acquired from a batch of known samples. In response to determining that there is a next image, the process returns to 266. In response to determining that there is a next image, the process flows to 274.

In 274, it is determined whether there are sufficient additional identifying feature metrics. In response to determining that there are not sufficient additional identifying feature metrics, the process flows to 284, a negative result is provided (e.g., provided to the system user via a display within the using tag identification system), and the process ends. In response to determining that there are sufficient additional identifying feature metrics, the process flows to 276. For example, if no additional identifying feature metrics are found, then the process has no data to generate a model and is unable to continue. If too few additional identifying feature metrics are found, it may be determined it is not worth generating and/or testing such a model, and/or that it is unlikely that a model generated with too few data points would be sufficiently reliable. The determination of whether there are sufficient additional identifying feature metrics is an experienced-based judgment that comes from working with the process of FIG. 2B. For example, it may be empirically determined that a minimum of 30, 50, 100, 200, 392, 5000, 9812, 1,000,000 or any other appropriate minimum number of additional identifying feature metrics (i.e., individual measurements of one or more additional identifying feature metrics) should be found before determining that there are sufficient additional identifying feature metrics to continue the process. In some embodiments, the sufficient number of additional identifying feature metrics is determined empirically by testing the generated model against known (or ground truth) images so as to achieve a desired level of confidence (e.g., 60%, 70%, 82%, 95%, 98%, 99.3%, or any other appropriate level of confidence when classifying samples in the next images. In some embodiments, it is determined whether any additional identifying feature metrics from the image match a known tag additional identifying feature metric in a library of sample types (e.g., above a threshold confidence value).

In 276, it is determined whether sufficient additional identifying feature metrics pass QC check(s). For example, it is determined whether there are sufficient additional identifying feature metrics of sufficient quality to be useful in the generation of a second model. In various embodiments, QC checks of additional identifying feature metrics comprise checking whether HSV parameters (e.g., absolute intensity or intensity relative to the background) of the additional identifying feature metrics are within, above, or below certain threshold limits. The relative HSV parameters may be in the form of a relative difference (i.e., the intensity of the additional identifying feature metrics minus background intensity) or a relative ratio (i.e., the intensity of the additional identifying feature metrics divided by background intensity).

In response to determining that sufficient additional identifying feature metrics do not pass QC check(s), the process flows to 284, a negative result is provided (e.g., provided to the system user via a display within the using tag identification system), and the process ends. In response to determining that the additional identifying feature metrics pass QC check(s), the process flows to 278.

In some embodiments, QC checks are performed before determining whether there are sufficient additional identifying feature metrics (i.e., process steps 274 and 276 are reversed in order). In some embodiments, QC checks are not performed (i.e., process step 276 is skipped over).

In various embodiments, the additional identifying feature metrics use pre-existing libraries and/or functions. For example, the libraries and functions required to enable recognition of a QR code may only require configuration of the appropriate image acquisition settings. In various embodiments, configurations of the libraries and functions being used are required. For example, the libraries and functions required to enable OCR may require that the number of characters and/or format of those characters be specified, but image acquisition, pre-processing, determination of feature metrics and/or related quality score comparison may not be required to generate the second model.

In some embodiments existing libraries and functions are combined with existing databases to provide product information based on the identifying feature. For example, a database listing all possible barcodes may be provided such that when a barcode is recognized the appropriate product information is provided as output.

In some embodiments ground truth images are provided in combination with existing algorithms. For example, in Key Point Template matching, a ground truth image of the additional identifying feature is provided to serve as a template of comparison against which other images are to be compared.

In 278, settings for model generation are provided. For example, settings specific to image acquisition, algorithm selection, image pre-processing, determination of additional identifying feature metrics, and the checking of feature metric quantity and quality within the known sample images are provided to the processor of the tag identification system. In some embodiments, the settings for model generation are saved in database (e.g., in a database of the tag identification system). In some embodiments, the settings for model generation are collectively saved in a configuration file for later recall (e.g., by the system user).

In 280, a second model is generated. For example, a second model utilizing one or more of the following models is generated: an OCR model, an object detection model, a support vector machine model, a neural network model, a bounding box model, a clustering algorithm, or a classifier algorithm. In some embodiments, OCR models utilize a Tesseract OCR engine. In various embodiments, OCR methods comprise one or more open-source methods (e.g., OCRopus, Kraken, Calamari OCR, Keras OCR, EasyOCR, etc.) or commercial OCR Application Programming Interfaces (e.g., Amazon Textract, Amazon Rekognition, Google Cloud Vision, Microsoft Azure Computer Vision, Cloudmersive, Free OCR, Mathpix, etc.). In various embodiments, a Hu Moment, a Histogram of Oriented Gradients, a Key Point Matching, or a Neural Network algorithm is used for logo detection. In various embodiments, an Object Detection algorithm is used to identify an object to either act as the identifying feature alone, or in combination with other algorithms.

In some embodiments, one or more neural network models are used to classify images of samples. The neural network model used to classify images of samples (i.e., ‘the classifier model’) assigns a class label to one or more portions of images outlined by a bounding box. In some embodiments, the classifier model uses sharp edge detection. In some embodiments, the classifier model uses machine vision. In some embodiments, the classifier model uses machine learning approaches. For example, the classifier model uses one or more neural network models to classify sample images that have been detected by the bounding box model. In various embodiments, the one or more neural network models used by the classifier model are the same, different, or a combination of same or different models as used by the bounding box model.

In various embodiments, the second model includes additional requirements to limit the possible output responses of the second model and/or to improve confidence in the output result. For example, the minimum number of key points may be defined for a Key Point Matching algorithm to ensure sufficient confidence that an image is comparable to the Key Point Template.

In 282, the second model is provided. For example, the second model is provided to the system user of the tag identification system (e.g., for verification and testing purposes). In some embodiments, the second model is saved to a database (e.g., to a database of the tag identification system or any other appropriate database).

In 284, a negative result is provided, and the process ends. For example, a negative result is provided to the system user of the tag identification system (e.g., via a display of the tag identification system), and the process ends. In some embodiments, a negative result is saved to a database (e.g., to a database of the tag identification system or any other appropriate database). For example, a negative result comprising a list of reasons as to why the process was unable to generate a second model is provided (e.g., insufficient additional identifying feature metrics identified, insufficient additional identifying feature metrics that passed the QC check, the actual number of additional identifying feature metrics identified and/or that passed QC check, or any other appropriate information).

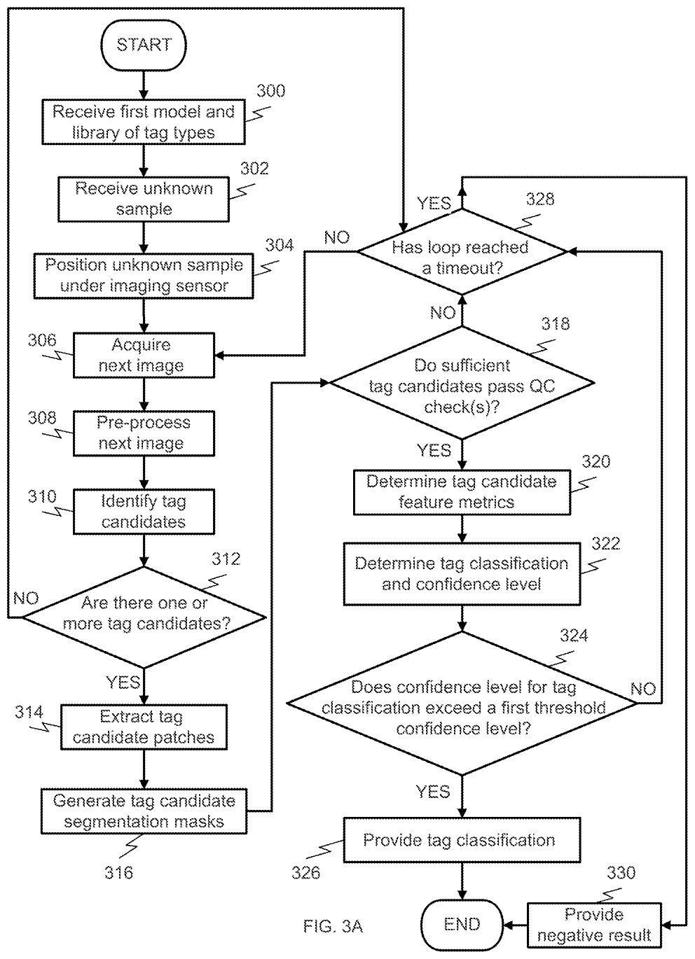

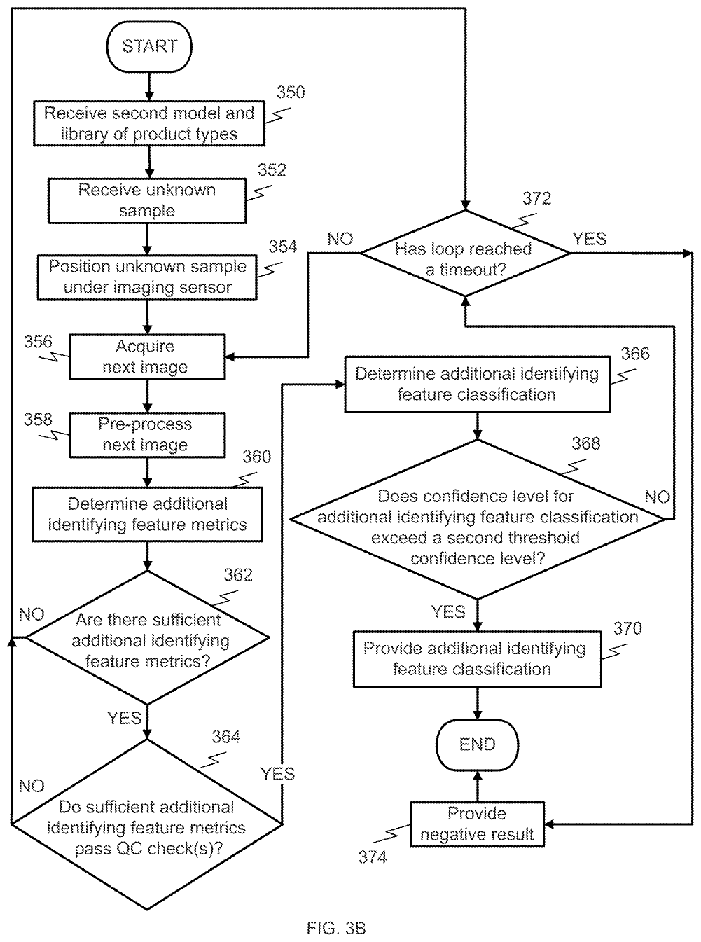

FIG. 3A is a flow diagram illustrating an embodiment of a process for classifying a tag. In some embodiments, the process of FIG. 3A is performed using tag identification system 100 of FIG. 1 (e.g., CPU 112 of FIG. 1). In the example shown, in 300, a first model and library of tag types are received. For example, a first model as generated by the process of FIG. 2A and a set of feature metrics corresponding to known tag types (i.e., a ‘library of tag types’) are received by a computer system (e.g., the computer system controlling the tag identification system). For example, the library of tag types comprises a set of tag feature metrics and/or the associated statistical thresholds deemed significant for tag type identification. In some embodiments, a library of tag types comprises a collection of sets of feature metric values, wherein each set of feature metric values corresponds to, and is used to identify, a particular tag type.

In various embodiments, tag feature metrics comprise one or more of a size, a shape, a color value, a saturation value, an intensity value, a color value standard deviation, a saturation value standard deviation, an intensity value standard deviation, a relative color value, a relative saturation value, or a relative intensity value, wherein the relative color, saturation, or intensity values are relative to the image background surrounding one or more tag types. In various embodiments, colors are determined using a hue, saturation, lightness (HSL) color model; a hue, saturation, value (HSV) color model; a red, green, blue (RGB) color model; or any other appropriate type of color model.

In 302, an unknown sample is received. For example, a sample containing one or more tag types is received by the user of the tag identification system, wherein the sample and/or the one or more tag types are unknown. For example, a to-be-identified pill with an applied unknown tag type (e.g., applied to the surface of the pills via a pill coating) is received.

In 304, the unknown sample is positioned under an imaging sensor. For example, the unknown sample is positioned under the imaging sensor (e.g., positioned by hand, using a fixture or mount, etc.) at the desired coordinate. For example, the sample is positioned by adjusting its position relative to the imaging sensor the sample is observable in the field of view of the tag identification system (e.g., as observable by a human user).

In 306, a next image is acquired. For example, an image of the unknown sample is acquired by the imaging sensor of the tag identification system. For example, an image is acquired using pre-determined image acquisition settings that have been incorporated into the first model and the acquired image routed to the computer memory and/or related database of the tag identification system. In various embodiments, the image sensor comprises a solid-state sensor, a CMOS sensor, a CCD sensor, a staring array, an RGB sensor, an IR sensor, an RGB and IR sensor, a Bayer pattern color sensor, a multiple band sensor, a monochrome sensor, or any other type of appropriate imaging sensor.

In various embodiments, the image is stored in computer memory, and/or saved in a data storage unit (e.g., a data storage unit of the computer system controlling the tag identification system). In various embodiments, the image is saved as an image file—for example, a tiff file, a png file, a jpg file, or any other appropriate image file format. In various embodiments, the image is provided to a system user (e.g., displayed on a monitor of the controlling computer system) and/or provided to a software application that allows the user to interact with the image.

In 308, the next image is pre-processed. For example, image pre-processing comprises one or more of an image cropping or binning, a white balance correction, an exposure correction (e.g., either automatically or via a calibration table), a background color subtraction, a background correction (i.e., adjusting for the fact that the surrounding target color may impact the perceived color of the tag), filtering out noise, etc.

In some embodiments, pre-processing comprises checking overall image quality. Image quality attributes considered in determining overall image quality comprise one or more of the following: image sharpness, noise, dynamic range, tone reproduction, contrast, color accuracy, distortion, vignetting, exposure accuracy, lateral chromatic aberration (i.e., color fringing), lens flare, color moiré, and/or other visual artifacts, including data compression and transmission losses (e.g., low quality JPEG), oversharpening ‘halos’, loss of fine, low-contrast detail, and repeatability of results. In various embodiments, image quality attributes are classified in terms of measuring only one specific type of degradation (e.g., blurring, blocking, or ringing), or taking into account all possible signal distortions, that is, multiple kinds of artifacts.

In various embodiments, image quality is assessed using objective or subjective methods. For example, image quality methods comprising one of more of single-stimulus, double-stimulus, full-reference, reduced-reference, no-reference, or any other appropriate image quality method is used to assess image quality and/or provide a quality score. For example, the images are passed through an image quality filter (e.g., a manual or automatic image quality filter) to determine a quality score for each image, wherein the quality score for each image is used to determine whether the images should be either discarded or used in generating a first model. In some embodiments, pre-processing of the next image is not performed (i.e., process step 308 is skipped over).

In 310, tag candidates are identified. For example, blob detection methods are employed to identify areas in the next image that exhibit properties that differ from the overall image background (e.g., brightness or color). A blob is a region of the image in which some properties are constant or approximately constant; all the points in a blob can be considered in some sense to be similar to each other. For example, blob detection methods comprise one or more algorithms based on determining local extrema (e.g., local maxima, local minima, specific color maxima, etc.), color thresholding, differential methods, (e.g., based on derivatives of the function with respect to position), etc. In some embodiments, the blob detection methods used to identify tag candidates are trained to look for properties that are consistent with images of tags (e.g., brightness, color, size, etc.). In some embodiments, blob detection parameters are provided by the first model.

In 312, it is determined whether there are one or more tag candidates. In response to determining that there are not one or more tag candidates, the process flows to 328. For example, if no tag candidates are found in the next image, then the process has no data to use for classification of a tag type and is thus directed to acquire another image to try again (assuming a loop timeout has not been reached). In response to determining that there are one or more tag candidates, the process flows to 314.

In 314, tag candidate patches are extracted. For example, patches of individual tags and/or tag cluster candidates in the next image are cropped out from the overall image background. Patches of individual tags or tag clusters candidates comprise localized regions surrounding and including images of the tag or tag cluster candidates. In some embodiments, patch extraction comprises cropping the one or more images to generate one or more patch images comprising an individual tag image and/or a cluster of tags image. In some embodiments, morphology and tag contours are used to select clusters of contiguous pixels in a mask that forms a cluster of tags. In some embodiment, tag candidate patch extraction parameters are provided by the first model.

For example, identified blobs in the next image are extracted from the image background after utilizing a bounding box model to localize and/or detect images of tag candidates. In various embodiments, the bounding box model comprises one or more of a Tensor Flow model, a convolutional neural network, a region-based convolutional neural network (R-CNN), a Fast R-CNN model, a Faster R-CNN model, a You Only Look Once (YOLO) model from the family of YOLO models, an EdgeBoxes model, or any other appropriate bounding box model.

In some embodiments, it is determined whether any extracted tag candidate patches from the image match a known tag feature in a library of tag types (e.g., above a threshold confidence value) in order to qualify as a tag candidate.

In 316, tag candidate segmentation masks are generated. For example, a binary segmentation mask is generated for each tag candidate patch (and/or tag candidate cluster patch) that has been extracted from the next image. Using this mask, only the relevant pixels for that tag candidate are selected, background pixels are zeroed, and the image is cropped down to a small patch that covers exactly the area of the tag candidate or tag candidate cluster. For example, pixels representing tag candidates that have been segmented from the image background are used to generate a binary segmentation mask. In some embodiments, binary segmentation masks are generated for each individual tag image and each cluster of tags. In some embodiments, delineation of the pixels comprises determining a foreground and a background. In some embodiments, a tag image foreground and background are used to generate a binary segmentation mask. In some embodiments, tag candidate segmentation mask parameters are provided by the first model.

In some embodiments, the original image is grayscale converted, then a threshold method applied, and finally the output is a binary image that bears a mask of gray and black. In some embodiments, tag morphology and contours are used to generate the binary segmentation mask. In some embodiments, image segmentation comprises delineation of pixels belonging to one or more tag candidates in a spectral image.

In various embodiments, classical imaging techniques for tag segmentation are used to detect tag boundaries (e.g., watershed transformation, morphological image processing, Laplacian of Gaussian (LoG) filters, pixel classification, etc.). In various embodiments, artificial intelligence (AI) imaging techniques are used for tag segmentation (e.g., U-Net (a Convolutional Network for Biomedical Image Segmentation), Mask R-CNN, etc.). In various embodiments, the next image is processed using a combination of one or more machine learning clustering algorithms (e.g., principal component analysis, K-Means, spectral angle mapping that is first trained on samples of known tag types, or any other appropriate algorithm). In some embodiments, traditional K-means clustering algorithms are sufficient for background vs. foreground detection. In some embodiments, segmentation performance can be further improved by scaling to a deep autoregressive segmentation model, that defines two clusters by separating on mutual information. In some embodiments, tag candidate segmentation masks are not generated (i.e., process step 316 is skipped over), and the process flows to 318.

In 318, it is determined whether sufficient tag candidates pass QC check(s). For example, it is determined whether sufficient tag candidates are of sufficient image quality to provide a tag classification. In various embodiments, tag candidate QC checks comprise checking whether the tag HSV parameters are within, above, or below certain threshold limits (e.g., either absolute or relative to the background). The relative HSV parameters may be in the form of a relative difference (i.e., tag intensity minus background intensity) or a relative ratio (i.e., tag intensity divided by background intensity).

In response to determining that sufficient tag candidates do not pass QC check(s), the process flows to 328. In response to determining that sufficient tag candidates pass QC check(s), the process flows to 320.

In some embodiments, QC checks are performed before determining whether there are one or more tag candidates (i.e., process steps 318 and 312 are reversed in order). In some embodiments, QC checks are not performed (i.e., process step 318 is skipped over).

In 320, tag candidate feature metrics are determined. For example, tag candidate feature metrics deemed significant for tag type identification, and/or the associated statistical thresholds for each tag type that have been established as indicating significance, are determined by the first model for each tag candidate image.

In various embodiments, tag candidate feature metrics comprise one or more of a size, a shape, a color value, a saturation value, an intensity value, a color value standard deviation, a saturation value standard deviation, an intensity value standard deviation, a relative color value, a relative saturation value, or a relative intensity value, wherein the relative color, saturation, or intensity values are relative to the image background surrounding one or more tag types. In various embodiments, colors are determined using a hue, saturation, lightness (HSL) color model; a hue, saturation, value (HSV) color model; a red, green, blue (RGB) color model; or any other appropriate type of color model.

In some embodiments, a first set of tag candidate feature metrics is generated by the first model extracting features of interest from each tag or tag-cluster image. In some embodiments, a second set of tag candidate feature metrics is generated by the first model extracting additional features of interest from each tag image (e.g., using deep feature extraction). In some embodiments, a complete set of tag candidate feature metrics is generated (e.g., generated by the first model). For example, a complete set of tag candidate feature metrics is generated by fusing the first and second sets of tag candidate feature metrics (i.e., feature fusion). In some embodiments, feature fusion comprises appending the second set of tag candidate feature metrics to the first set of tag candidate feature metrics to generate a complete set of tag candidate feature metrics.

In 322, tag classification and confidence level are determined. For example, tag classification and confidence level are determined by the first model. For example, it is determined whether the sample includes a number of tags of a tag type exceeding a threshold confidence level, so the sample is deemed to contain the tag type. For example, a tag type is determined by classifying features of one or more images of tags and/or tag clusters and comparing to known tag feature classifications or types in the library of tag types. For example, features of the one or more images of tags and/or tag clusters comprise spectral and spatial characteristics associated with specific tag types of interest. Such characteristics include, for example, spectral profiles, spectral signatures, the shape and size of the imaged tags, etc. In various embodiments, application of the first model to determine the classification of the tag provides a binary level of confidence or reports the confidence as a separate metric (e.g., distance).

In some embodiments, tag classification comprises determining the type of tag in one or more tag candidate segmentation masks (e.g., using the determined tag candidate feature metrics). In some embodiments, tag classification comprises determining the type of tag (e.g., using the determined tag candidate feature metrics). In various embodiments, the type of tag comprises one of or more of the following tag types: a microtag, a taggant, a chemical marker, a physical marker, a rugate filter, an interference filter, a pigment, a flake, a platelet, or a granule, or any other appropriate type of tag. For example, the tag comprises one or more, or one or more combinations of: silicon, silicon dioxide, potassium aluminum silicate, mica, titanium dioxide, pigmented or dyed metallic and metallicized substrates, polymeric materials, a combination of high and low refractive index thin films, or any other material whose properties are differentiated from a bulk media in which the tag is embedded (e.g., for a purpose of identification).

In some embodiments, tag classification utilizes tag shape and/or size information as determined from the one or more tag candidate segmentation masks. In some embodiments, classification labels comprise characteristics of the input image (e.g., intensity, shape, or color aspects) that are summarized by numerical vectors (i.e., feature vectors).

In some embodiments, the probabilities generated by the classification algorithm (e.g., the classification algorithm that is part of the first model) are used to classify each tag candidate segmentation mask (e.g., by assigning a class label to each tag candidate segmentation mask). In some embodiments, classification is achieved using an FCNN. In various embodiments, tag type classification utilizes a hybrid deep-learning framework, a long-short term memory (LSTM) network, a deep residual network (e.g., one of the family of ResNet algorithm such as ResNet50, ResNet50 with Keras, ResNet-101, ResNet-152, etc.), and/or a 1D CNN.

In some embodiments, one or more machine learning models are used to classify tag candidate segmentation masks (e.g., the one or more neural network models that are part of the first model). For example, a support vector machine model, a neural network model, a bounding box model, a clustering algorithm, or a classifier algorithm, or any other appropriate machine learning model.

In some embodiments, determining the tag classification tag comprises matching tag candidate feature metrics to known feature classifications and/or types within the library of tag types above a threshold level of confidence (e.g., above a 70% threshold level of confidence, above a 75% threshold level of confidence, above an 80% threshold level of confidence, above a 90% threshold level of confidence, above a 95% threshold level of confidence, above a 98% threshold level of confidence, or any other appropriate threshold level of confidence).

In 324, it is determined whether the confidence level for tag classification exceeds a first threshold confidence level. For example, it is determined whether the confidence level for tag classification exceeds a first threshold confidence level of 98% confidence. In response to determining that the confidence level for tag classification does not exceed a first threshold confidence level, the process flows to 328. In response to determining that the confidence level for tag classification exceeds a first threshold confidence level, the process flows to 326. In various embodiments, the threshold confidence level provided by the first model is in the form of a binary threshold, probability, or any other appropriate metric relevant to the specific model algorithm (e.g., distance, number of keypoints, etc.).

In 326, the tag classification is provided, and the process ends. For example, the tag classification is provided to a system user (e.g., displayed on a monitor of the controlling computer system) and/or provided to a software application that allows the user to interact with the program running on the tag identification system, and the process ends. For example, in the case of the unknown sample being a pill that has been tagged with TruTag™ microtags, a tag classification indicating that the pill has been found to contain one or more TruTag microtags is provided. In some embodiments, the authenticity of the unknown sample is also confirmed (e.g., as deemed authentic by the presence of a known security taggant such as TruTag microtags). In some embodiments, a level of confidence is provided. For example, the pill is authenticated as genuine with a 99% level of confidence, the result provided and recorded in the database of the tag identification system, and the user is provided an option to analyze another known sample. In various embodiments the process of FIG. 3B is run concurrently (i.e., in parallel) to the process of FIG. 3A, or before or after the process of FIG. 3A (i.e., in series), and the user is provided with the product type of the unknown sample as well as indicating the tag type (e.g., indicating that the product is authentic).

For example, the pill is identified as an authentic oxycodone hydrochloride tablet containing 10 mg of active ingredient. In some embodiments, additional identifying features are displayed to the user (e.g., a picture of the pill, a manufacturer's logo, a National Drug Code (NDC), an expiration date, or any other appropriate additional identifying information). For example, such additional identifying feature information is stored as metadata in the library of tag types. For example, a relationship between the related product metadata and the TruTag microtag has been previously established and associated with a unique spectral signature of the TruTag microtag. In another example, it is the combination of additional identifying information (e.g., pill shape, color, size, debossing mark symbology, etc.) and one or more unique attributes of the TruTag microtag (e.g., spectral signature, microtag quantity (e.g., a quantity per unit area), reflectance or brightness value, etc.) that provides a link to related product metadata stored in the library of tag types.

In 328, it is determined whether the loop has reached a timeout. For example, it is determined whether the loop has reached a timeout as indicated by pre-defined configuration settings within the first model, defined by the system user, defined by a time, defined by a limited number of attempts to successfully classify the tag type, defined by number of images processed, or any other appropriate method of indicating a timeout has been reached. In response to determining that the loop has not reached a timeout, the process returns to 306. In response to determining that the loop has reached a timeout, the process flows to 330. In some embodiments, the timeout is configured to allow for infinite next images until manual intervention by the system user.

In 330, a negative result is provided, and the process ends. For example, a negative result is provided to the system user of the tag identification system (e.g., via a display of the tag identification system), and the process ends. In some embodiments, a negative result is saved to a database (e.g., to a database of the tag identification system or any other appropriate database). For example, a negative result comprising a list of reasons as to why the process was unable to classify the unknown tag type is provided (e.g., insufficient tag candidates identified, insufficient tag candidates that passed the QC check, the actual number of tag candidates identified and/or that passed QC check, or any other appropriate information).

FIG. 3B is a flow diagram illustrating an embodiment of a process for classifying additional identifying features. In some embodiments, the process of FIG. 3B is performed using tag identification system 100 of FIG. 1 (e.g., CPU 112 of FIG. 1). In the example shown, in 350, a second model and library of product types are received. For example, a second model as generated by the process of FIG. 2B and a set of additional identifying feature metrics corresponding to known product types (i.e., a ‘library of product types’) are received by a computer system (e.g., the computer system controlling the tag identification system). For example, the library of product types comprises a set of additional identifying feature metrics and/or the associated statistical thresholds deemed significant for additional identifying feature classification (i.e., product type identification).

Additional identifying features and feature metrics comprise one or more of a quick response (QR) code, a barcode, a two-dimensional (2D) matrix, a logo, a serial number, an item shape, an item size, a luminosity, a color, a mark, an indicium, a randomly serialized marker, text and other symbology types, or any other appropriate additional identifying feature. For example, text and other symbology types include one or more of a debossing mark on a drug tablet, a unique identifier imprinted on a drug capsule, product information printed on a label (e.g., the National Drug Code number), a logo, a serial number, etc. By determining one or more additional identifying features and/or feature metrics, the tag identification system can identify a product type that is associated with the determined additional identifying features and/or feature metrics within the library of product types. In some embodiments, providing the additional identifying feature classification is synonymous with identifying and providing the product type.

In 352, an unknown sample is received. For example, a sample containing one or more tag types is received by the user of the tag identification system, wherein the sample and/or the one or more tag types are unknown. For example, a to-be-identified pill with an applied unknown tag type (e.g., applied to the surface of the pills via a pill coating) is received. In some embodiments, a sample not containing any tag types is received by the user of the tag identification system, wherein the sample is unknown. For example, a user of the tag identification system is interested only in identifying the product type independent of whether it contains a security tag or other tag type.

In 354, the unknown sample is positioned under an imaging sensor. For example, the unknown sample is positioned under the imaging sensor (e.g., positioned by hand, using a fixture or mount, etc.) at the desired coordinate. For example, the sample is positioned by adjusting its position relative to the imaging sensor the sample is observable in the field of view of the tag identification system (e.g., as observable by a human user).

In 356, a next image is acquired. For example, an image of the unknown sample is acquired by the imaging sensor of the tag identification system. For example, an image is acquired using pre-determined image acquisition settings that have been incorporated into the second model and the acquired image routed to the computer memory and/or related database of the tag identification system. In various embodiments, the image sensor comprises a solid-state sensor, a CMOS sensor, a CCD sensor, a staring array, an RGB sensor, an IR sensor, an RGB and IR sensor, a Bayer pattern color sensor, a multiple band sensor, a monochrome sensor, or any other type of appropriate imaging sensor.

In various embodiments, the image is stored in computer memory, and/or saved in a data storage unit (e.g., a data storage unit of the computer system controlling the tag identification system). In various embodiments, the image is saved as an image file—for example, a tiff file, a png file, a jpg file, or any other appropriate image file format. In various embodiments, the image is provided to a system user (e.g., displayed on a monitor of the controlling computer system) and/or provided to a software application that allows the user to interact with the image.

In 358, the next image is pre-processed. For example, image pre-processing comprises one or more of an image cropping or binning, a white balance correction, an exposure correction (e.g., either automatically or via a calibration table), a background color subtraction, a background correction (i.e., adjusting for the fact that the surrounding target color may impact the perceived color of the tag), filtering out noise, etc.

In some embodiments, pre-processing comprises checking overall image quality. Image quality attributes considered in determining overall image quality comprise one or more of the following: image sharpness, noise, dynamic range, tone reproduction, contrast, color accuracy, distortion, vignetting, exposure accuracy, lateral chromatic aberration (i.e., color fringing), lens flare, color moiré, and/or other visual artifacts, including data compression and transmission losses (e.g., low quality JPEG), oversharpening ‘halos’, loss of fine, low-contrast detail, and repeatability of results. In various embodiments, image quality attributes are classified in terms of measuring only one specific type of degradation (e.g., blurring, blocking, or ringing), or taking into account all possible signal distortions, that is, multiple kinds of artifacts.

In various embodiments, image quality is assessed using objective or subjective methods. For example, image quality methods comprising one of more of single-stimulus, double-stimulus, full-reference, reduced-reference, no-reference, or any other appropriate image quality method is used to assess image quality and/or provide a quality score. For example, the images are passed through an image quality filter (e.g., a manual or automatic image quality filter) to determine a quality score for each image, wherein the quality score for each image is used to determine whether the images should be either discarded or used in generating a first model. In some embodiments, pre-processing of the next image is not performed (i.e., process step 358 is skipped over).

In 360, additional identifying feature metrics are determined. For example, additional identifying features and/or associated additional identifying feature metrics deemed significant for product type identification, and/or the associated statistical thresholds for each product type that have been established as indicating significance, are determined. Additional identifying features and feature metrics comprise one or more of a quick response (QR) code, a barcode, a two-dimensional (2D) matrix, a logo, a serial number, an item shape, an item size, a luminosity, a color, a mark, an indicium, a randomly serialized marker, text and other symbology types, or any other appropriate additional identifying feature. For example, text and other symbology types include one or more of a debossing mark on a drug tablet, a unique identifier imprinted on a drug capsule, product information printed on a label (e.g., the National Drug Code number), a logo, a serial number, etc. In some embodiments, the parameters used for additional identifying feature determination are provided by the second model.

For example, it is determined that the additional identifying feature of color is deemed significant for product type identification, but also that the precise color (i.e., the associated additional identifying feature metric) is required to differentiate one product from another. For example, the color red may be considered to help classify or narrow a product type into one of several possible product types that are also ‘red’, but it is determined further that the exact shade of red (e.g., red with a wavelength of 632 nm) is required to differentiate a specific product from other products that are also red, but of different hues (i.e., different color wavelengths). Further, for example, red with a wavelength of 632 nm with an associated statistical threshold of +/−3 nm is used as forming an acceptance criterion to differentiate one product from other products that are also red, but of different hues.

In various embodiments, one or more additional identifying features and/or additional identifying feature metrics are determined. In various embodiments, additional identifying features and/or additional identifying feature metrics are automatically determined.

In various embodiments, optical character recognition (OCR) methods are used to read text and/or feature detection algorithms are used to identify other types of symbology imprinted on the tagged item. In some embodiments, OCR methods utilize a Tesseract OCR engine. In various embodiments, OCR methods comprise one or more open-source methods (e.g., OCRopus, Kraken, Calamari OCR, Keras OCR, EasyOCR, etc.) or commercial OCR Application Programming Interfaces (e.g., Amazon Textract, Amazon Rekognition, Google Cloud Vision, Microsoft Azure Computer Vision, Cloudmersive, Free OCR, Mathpix, etc.). In various embodiments, a Hu Moment, a Histogram of Oriented Gradients, a Key Point Matching, or a Neural Network algorithm is used for logo detection.

In 362, it is determined whether there are sufficient additional identifying feature metrics. In response to determining that there are not sufficient additional identifying feature metrics, the process flows to 372. In response to determining that there are sufficient additional identifying feature metrics, the process flows to 364. For example, if no additional identifying feature metrics are found, then the process has no data to identify a product type and is unable to continue without acquiring a next image. If too few additional identifying feature metrics are found, it may be previously determined that the outcome could be ambiguous or otherwise insufficiently reliable. The determination of whether there are sufficient additional identifying feature metrics is an experienced-based judgment that comes from testing the process of FIG. 3B (e.g., after training the process using the process of FIG. 2B). For example, it may be empirically determined that a minimum of 3, 5, 10, or any other appropriate minimum number of additional identifying feature metrics should be found before determining that there are sufficient additional identifying feature metrics to continue the process and achieve the desired level of confidence.

In 364, it is determined whether sufficient additional identifying feature metrics pass QC check(s). For example, it is determined whether there are sufficient additional identifying feature metrics of sufficient quality to be useful in the classification of the additional identifying feature metrics (e.g., to identify the product type of the unknown sample). In various embodiments, QC checks of additional identifying feature metrics comprise checking whether HSV parameters (e.g., absolute intensity or intensity relative to the background) of the additional identifying feature metrics are within, above, or below certain threshold limits. The relative HSV parameters may be in the form of a relative difference (i.e., the intensity of the additional identifying feature metrics intensity minus background intensity) or a relative ratio (i.e., the intensity of the additional identifying feature metrics intensity divided by background intensity).

In response to determining that sufficient additional identifying feature metrics do not pass QC check(s), the process flows to 372. In response to determining that the additional identifying feature metrics pass QC check(s), the process flows to 366.

In some embodiments, QC checks are performed before determining whether there are sufficient additional identifying feature metrics (i.e., process steps 364 and 362 are reversed in order). In some embodiments, QC checks are not performed (i.e., process step 364 is skipped over).

In 366, additional identifying feature classification is determined. For example, additional identifying feature classification is determined by the tag identification system so as to identify the product type of the unknown sample. In some embodiments, it is determined whether any additional identifying feature metrics from the next image match a known additional identifying feature metric in the library of product types (e.g., above a threshold confidence value). For example, for solid oral dosage form human drug products, the imprint code on the tablet or capsule, when used in conjunction with the product's size, shape, and color, permits the identification of the drug product, the active ingredient(s), strength, and the manufacturer or distributor of the product. This is enabled by use of a look-up table stored in the library of product types, wherein the determined additional identifying feature metrics are linked to the associated drug product information for a given product type.

In 368, it is determined whether the confidence level for the additional identifying feature classification exceeds a second threshold confidence level. For example, it is determined whether the confidence level for additional identifying feature classification exceeds a second threshold confidence level of 99.5% confidence. In response to determining that the confidence level for tag classification does not exceed a second threshold confidence level, the process flows to 372. In response to determining that the confidence level for tag classification exceeds a second threshold confidence level, the process flows to 370. In various embodiments, the threshold confidence level provided by the first model is in the form of a binary threshold, probability, or any other appropriate metric relevant to the specific model algorithm (e.g., distance, number of keypoints, etc.).

In 370, the additional identifying feature classification is provided, and the process ends. For example, the additional identifying feature classification is provided to a system user (e.g., displayed on a monitor of the controlling computer system) and/or provided to a software application that allows the user to interact with the program running on the tag identification system, and the process ends. For example, in the case of the unknown sample being a pill, an additional identifying feature classification indicating the pill type is provided. In some embodiments, a level of confidence is also provided. For example, the pill is identified as an oxycodone hydrochloride tablet with a 99% level of confidence. In some embodiments, the authenticity of the unknown sample is also confirmed (e.g., as deemed authentic by the presence of a known security taggant such as TruTag microtags).

In various embodiments the process of FIG. 3A is run concurrently (i.e., in parallel) to the process of FIG. 3B, or before or after the process of FIG. 3B (i.e., in series). For example, the user is provided with a response commensurate with the combination of the result of both the tag type determination and additional identifying feature determination (e.g., the product type, the tag type, that the product is authentic, etc.). In some embodiments, the process of FIG. 3B is not performed at all. In some embodiments, the first and second model are combined into a single model.

For example, the pill is identified as an authentic oxycodone hydrochloride tablet containing 10 mg of active ingredient. In some embodiments, additional identifying features are displayed to the user (e.g., a picture of the pill, a manufacturer's logo, an NDC code, an expiration date, or any other appropriate additional identifying information). For example, such additional identifying feature information is stored as metadata in the library of product types. For example, a relationship between the related product metadata and the TruTag microtag has been previously established and associated with a unique spectral signature of the TruTag microtag. In another example, it is the combination of additional identifying information (e.g., pill shape, color, size, debossing mark symbology, etc.) and one or more unique attributes of the TruTag microtag (e.g., spectral signature, microtag quantity (e.g., a quantity per unit area), reflectance or brightness value, etc.) that provides a link to related product metadata stored in the library of product types.

In 372, it is determined whether the loop has reached a timeout. For example, it is determined whether the loop has reached a timeout as indicated by pre-defined configuration settings within the second model, defined by the system user, defined by a time, defined by a limited number of attempts to successfully classify the additional identifying features or feature metrics, defined by the number of frames, or any other appropriate method of indicating a timeout has been reached. In response to determining that the loop has not reached a timeout, the process returns to 356. In response to determining that the loop has reached a timeout, the process flows to 374. In some embodiments, the timeout is configured to allow for infinite next images until manual intervention by the system user.

In 374, a negative result is provided, and the process ends. For example, a negative result is provided to the system user of the tag identification system (e.g., via a display of the tag identification system), and/or provided to a software application that allows the user to interact with the program running on the tag identification system, and the process ends. In some embodiments, a negative result is saved to a database (e.g., to a database of the tag identification system or any other appropriate database). For example, a negative result comprising a list of reasons as to why the process was unable to classify the additional identifying features is provided (e.g., insufficient additional identifying feature metrics identified, insufficient additional identifying feature metrics that passed the QC check, the actual number of additional identifying features identified and/or that passed QC check, or any other appropriate information).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system comprising:
an imaging sensor, wherein the imaging sensor acquires one or more images of one or more tags from light reflected from the one or more tags on a tagged item; and
a processor configured to:
receive the one or more images;
receive a library of tag types;
determine, using the one or more images, a set of feature metrics, wherein determining the set of feature metrics uses a machine learning algorithm and is based at least in part on one or more of an image processing, manipulation, or correction;
determine, using the set of feature metrics and the library of tag types, a tag type of the one or more tags in the one or more images, wherein determining the tag type is based at least in part on one or more of: a local maxima determination, a bounding box generation, a tag candidate patch extraction, a tag candidate segmentation, a tag candidate feature metric determination, and a comparison to a model;
determine a confidence level of the tag type; and
in response to the confidence level being above a threshold level, provide the tag type determined.

2. The system as in claim 1, wherein the set of feature metrics is determined for each of the one or more images.

3. The system as in claim 1, wherein the set of feature metrics is determined for each of the one or more tags in the one or more images.

4. The system as in claim 1, wherein a tag of the one or more tags comprises a microtag, a taggant, a chemical marker, a physical marker, a rugate filter, an interference filter, a pigment, a flake, a platelet, or a granule.

5. The system as in claim 4, wherein the tag comprises one or more, or one or more combinations of: silicon, silicon dioxide, potassium aluminum silicate, mica, titanium dioxide, pigmented or dyed metallic and metallicized substrates, polymeric materials, a combination of high and low refractive index thin films, or any other material whose properties are differentiated from a bulk media in which the tag is embedded for a purpose of identification.

6. The system as in claim 1, wherein the tagged item comprises a drug product, a food product, a tablet, a capsule, a label, a container, a seed, a consumer product (or any part thereof), an electronic material (or any part thereof), an industrial product (or any part thereof), or a package.

7. The system as in claim 1, wherein the processor is also configured to determine one or more additional identifying features of the tagged item.

8. The system as in claim 7, wherein an additional identifying feature of the one or more additional identifying features comprises one or more of a quick response code, a barcode, a two-dimensional matrix, a data matrix, a logo, a serial number, an item shape, a luminosity, a color, a mark, an indicium, or a randomly serialized marker.

9. The system as in claim 1, wherein the processor is also configured to determine an identity of the tagged item based at least in part on one or more of an additional identifying feature of the tagged item.

10. The system as in claim 1, wherein the set of feature metrics comprises one or more tag characteristics deemed significant for tag type determination, and/or an associated statistical threshold for each have been established as indicating significance, are used to generate a set of feature metrics for each tag type.

11. The system of claim 10, wherein the set of feature metrics comprise one or more of a size, a shape, a color, a saturation, or intensity.

12. The system of claim 11, wherein the color, the saturation, or the intensity comprise any of an absolute value, a standard deviation, or a relative value.

13. The system as in claim 11, wherein the color is a result of a tag's inherent chemical or physical material properties or is a result of one or more coatings on a tag surface.

14. The system of claim 10, wherein the set of feature metrics are automatically determined.

15. The system of claim 10, wherein the set of feature metrics are manually determined by a human user.

16. The system as in claim 1, wherein one or more ground truth images of one or more known tag types are used to train the system.

17. The system as in claim 1, wherein a new tag type is added to the library of tag types after training the system to differentiate the new tag type from known tag types in the library of tag types.

18. The system as in claim 1, wherein the tag type corresponds to a pre-defined set of feature metric values.

19. The system as in claim 18, wherein the pre-defined set of feature metric values corresponding to a known tag type is modified, if necessary, as the library of tag types grows.

20. The system as in claim 1, wherein the one or more images are acquired using a mobile device.

21. The system of claim 20, wherein the mobile device comprises a smartphone, a microscope, or a tablet.

22. The system as in claim 1, wherein an image segmentation comprises a delineation of pixels belonging to the tag types in the one or more images.

23. The system as in claim 22, wherein the delineation of the pixels comprises determining a foreground and a background, and wherein the foreground and the background are used to generate a binary segmentation mask.

24. The system as in claim 1, wherein the image sensor comprises a solid-state sensor, a CMOS sensor, a CCD sensor, a staring array, an RGB sensor, an IR sensor, an RGB and IR sensor, a Bayer pattern color sensor, a multiple band sensor, or a monochrome sensor.

25. The system as in claim 1, wherein determining the tag type uses one or more machine learning algorithms comprising: a support vector machine, neural network model, a bounding box model, a clustering algorithm, and/or a classifier algorithm.

26. A method, comprising:
receiving one or more images, wherein an imaging sensor acquires one or more images of one or more tags from light reflected from the one or more tags on a tagged item;
receiving a library of tag types;
determining, using the processor, a set of feature metrics using the one or more images, wherein determining the set of feature metrics uses a machine learning algorithm and is based at least in part on one or more of an image processing, manipulation, or correction;
determining, using the set of feature metrics and the library of tag types, a tag type of the one or more tags in the one or more images, wherein determining the tag type is based at least in part on one or more of: a local maxima determination, a bounding box generation, a tag candidate patch extraction, a tag candidate segmentation, a tag candidate feature metric determination, and/or a comparison to a model;
determining a confidence level of the tag type; and
in response to the confidence level being above a threshold level, providing the tag type determined.

27. A computer program product, the computer program product being embodied in a non-transitory computer readable storage medium and comprising computer instructions for:
receiving one or more images, wherein an imaging sensor acquires one or more images of one or more tags from light reflected from the one or more tags on a tagged item;
receiving a library of tag types;
determining, using the one or more images, a set of feature metrics, wherein determining the set of feature metrics uses a machine learning algorithm and is based at least in part on one or more of an image processing, manipulation, or correction;
determining, using the set of feature metrics and the library of tag types, a tag type of the one or more tags in the one or more images, wherein determining the tag type is based at least in part on one or more of: a local maxima determination, a bounding box generation, a tag candidate patch extraction, a tag candidate segmentation, a tag candidate feature metric determination, and a comparison to a model;
determining a confidence level of the tag type; and
in response to the confidence level being above a threshold level, providing the tag type determined.
